(19) United States
(12) Patent Application Publication
(10) Pub. No.: US 2018/0027031 A1
(43) Pub. Date: Jan. 25, 2018

(54) INFORMATION PROCESSING APPARATUS, INFORMATION PROCESSING SYSTEM, AND INFORMATION PROCESSING METHOD

(71) Applicant: Itaru KODAIRA, Kanagawa (JP)

(72) Inventor: Itaru KODAIRA, Kanagawa (JP)

(73) Assignee: Ricoh Company, Ltd., Tokyo (JP)

(21) Appl. No.: 15/650,179

(22) Filed: Jul. 14, 2017

(30) Foreign Application Priority Data
Jul. 22, 2016 (JP) 2016-144703
Apr. 27, 2017 (JP) 2017-088858

(51) Int. Cl. H04L 29/06; G06F 17/30; H04L 12/18; H04N 7/15

(52) U.S. Cl. CPC H04L 65/1089; H04L 65/403; H04N 7/152; G06F 17/30905; H04L 12/1822

(57) ABSTRACT

An information processing apparatus includes a memory and circuitry. The memory stores shared information, identification information identifying each file of shared information in association with identification information of a group, and user identification information in association with the identification information of the group. The circuitry associates, with at least one file of shared information, masking information defining a masking target that a different group from the group associated with the file of the shared information is restricted from using. The circuitry accepts, from an information terminal, designation of a group for usage of the shared information. The circuitry determines whether any file of the shared information associated with the designated group is associated with the masking information. The circuitry determines one or more files of shared information to be transmitted to the information terminal. The circuitry transmits the determined shared information to the information terminal.

### CROSS-REFERENCE TO RELATED APPLICATIONS

This patent application is based on and claims priority pursuant to 35 U.S.C. §119(a) to Japanese Patent Application Nos. 2016-144703, filed on Jul. 22, 2016 and 2017-088858, filed on Apr. 27, 2017 in the Japan Patent Office, the entire disclosures of which are hereby incorporated by reference herein.

### BACKGROUND

### Technical Field

The present disclosure relates to an information processing apparatus, an information processing system, and an information processing method.

### Description of the Related Art

A network conference system has already been proposed that enables conference participants to hold a conference in a restricted network environment and view presentation materials only in that restricted network environment. This prevents the presentation material from leaking out.

In such conventional network conference systems, presentation materials are stored in an image processing apparatus, for example, that has multiple functions such as a copier function, a network printer function, a scanner function, and a document server function. Conference participants are able to view the materials stored in the image processing apparatus from their own information terminals, each being connected to the image processing apparatus. Further, to enable a non-participant, i.e., a person who does not participate in the conference to view a part of the presentation materials, data for disclosure are generated constituted by an extracted range that is allowed to be disclosed to the non-participant, and the generated data are stored in the image processing apparatus. The non-participant is able to access only the data for disclosure from his/her information terminal and view the data for disclosure on the information terminal. The non-participant is not able to access data other than the data for disclosure.

### SUMMARY

An information processing apparatus includes a memory and circuitry. The memory stores shared information, identification information identifying each file of shared information in association with identification information of a group, and user identification information in association with the identification information of the group. The circuitry associates, with at least one file of shared information, masking information defining a masking target that a different group from the group associated with the file of the shared information is restricted from using. The circuitry accepts, from an information terminal, designation of a group for usage of the shared information. The circuitry determines whether any file of the shared information associated with the designated group is associated with the masking information. The circuitry determines one or more files of shared information to be transmitted to the information terminal. The circuitry transmits the determined shared information to the information terminal.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 a schematic view illustrating an example configuration of an information processing system according to a first embodiment of the present disclosure;

FIG. 2 is a block diagram illustrating an example hardware configuration of an information processing server according to the first embodiment;

FIG. 3 is a block diagram illustrating an example functional configuration of the information processing server according to the first embodiment;

FIG. 4 illustrates an example of user information according to the first embodiment;

FIG. 5 illustrates an example of the conference participant information according to the first embodiment;

FIG. 6 illustrates an example of presentation material management information according to the first embodiment;

FIG. 7 is a block diagram illustrating an example hardware configuration of an information terminal according to the first embodiment;

FIG. 8 is a block diagram illustrating an example functional configuration of the information terminal according to the first embodiment;

FIG. 9 illustrates an example of functions provided by a client application according to the first embodiment;

FIG. 10 is a flowchart illustrating steps in an operation of setting masking information in the presentation material management information according to the first embodiment;

FIG. 11 illustrates an example of a display screen displayed on the information terminal when generating the masking information according to the first embodiment;

FIG. 12 is a flowchart illustrating steps in an operation of transmitting presentation material according to the first embodiment;

FIG. 13 is a flowchart illustrating steps in an operation of acquiring a viewing permission list according to the first embodiment;

FIG. 14 illustrates an example of a display screen displayed on the information terminal in a transmission process of the presentation material according to an embodiment of the present disclosure;

FIG. 15 is a block diagram illustrating an example functional configuration of the information processing server according to a second embodiment of the present disclosure;

FIG. 16 illustrates an example of the presentation material management information according to the second embodiment;

FIG. 17 is a flowchart illustrating steps in an operation of setting the masking information according to the second embodiment;

FIG. 18 illustrates an example of a setting screen for setting masking information on the information terminal according to the second embodiment;

FIG. 19 is a flowchart illustrating steps in an operation of acquiring the viewing permission list according to the second embodiment;

FIG. 20 illustrates an example of a display screen displayed on the information terminal in a transmission process of presentation material according to the second embodiment;

FIG. 21 illustrates designation of an area in a file according to a third embodiment of the present disclosure;

FIG. 22 illustrates an example of the presentation material management information according to the third embodiment;

FIG. 23 is a flowchart illustrating steps in an operation of setting the masking information according to the third embodiment;

FIGS. 24A and 24B illustrate an example of a setting screen for setting the masking information on the information terminal according to the third embodiment;

FIGS. 25A and 25B are a flowchart illustrating steps in an operation of acquiring the viewing permission list according to the third embodiment;

FIG. 26 illustrates an example of a display screen displayed on the information terminal in a transmission process of presentation materials according to the third embodiment;

FIG. 27 illustrates an example of presentation material management information according to a fourth embodiment of the present disclosure;

FIG. 28 is a flowchart illustrating steps in an operation of setting the masking information according to the fourth embodiment;

FIGS. 29A and 29B illustrate an example of a setting screen for setting masking information on the information terminal according to the fourth embodiment;

FIGS. 30A to 30C are a flowchart illustrating steps in an operation of acquiring the viewing permission list according to the fourth embodiment;

FIG. 31 illustrates an example of a display screen displayed on the information terminal in a transmission process of presentation materials according to the fourth embodiment;

FIG. 32 illustrates an example of presentation material management information according to a fifth embodiment of the present disclosure;

FIG. 33 illustrates an example of validation or invalidation of masking information, depending on combinations of a readout condition that is set in a second conference and a mask execution condition in the presentation material management information according to the fifth embodiment;

FIG. 34 illustrates an example of a setting screen for setting the masking information on the information terminal according to the fifth embodiment;

FIG. 35 schematically illustrates how presentation materials are viewed on the information terminal according to the fifth embodiment;

FIG. 36 is a block diagram illustrating an example functional configuration of an information processing server according to a sixth embodiment of the present disclosure;

FIG. 37 illustrates an example of human resource information according to the sixth embodiment;

FIG. 38 illustrates an example of access authorization information according to the sixth embodiment;

FIG. 39 is a flowchart illustrating steps in an operation of setting a readout condition performed by the information processing server according to the sixth embodiment;

FIG. 40 is a block diagram illustrating an example hardware configuration of a projector according to an embodiment of the present disclosure;

FIG. 41 is a block diagram illustrating an example hardware configuration of an electronic whiteboard according to an embodiment of the present disclosure;

FIG. 42 is a block diagram illustrating an example hardware configuration of a multifunction peripheral according to an embodiment of the present disclosure;

FIG. 43 is a flowchart illustrating steps in an operation of transmitting presentation material according to a seventh embodiment of the present disclosure;

FIG. 44 is a flowchart illustrating steps in an operation of acquiring a viewing permission list according to the seventh embodiment;

FIGS. 45A and 45B illustrate an example of a display screen displayed on the information terminal in a transmission process of the presentation material according to the seventh embodiment, and

FIG. 46 is a flowchart illustrating steps in an operation of outputting the presentation materials according to the seventh embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Hereinafter, a description is given of several embodiments of an information processing apparatus, an information processing system, an information processing method, and a non-transitory computer-readable medium.

Further, a description is given of an example in which an information processing system according to the present embodiment is applied to a conference system. The conference system is just an example of a system to which the information processing system can be applied. For example, the information processing system may be applied to a system in which information shared among a first group including multiple information terminals is referenced by a second group including multiple information terminals.

Further, in an example described below, presentation materials as an example of the shared information used in a first conference (the first group) are stored in a storage unit on a network, and a part of the presentation materials stored in the storage unit is used in a second conference (the second group) that is held by members including a person who does not attend at the first conference.

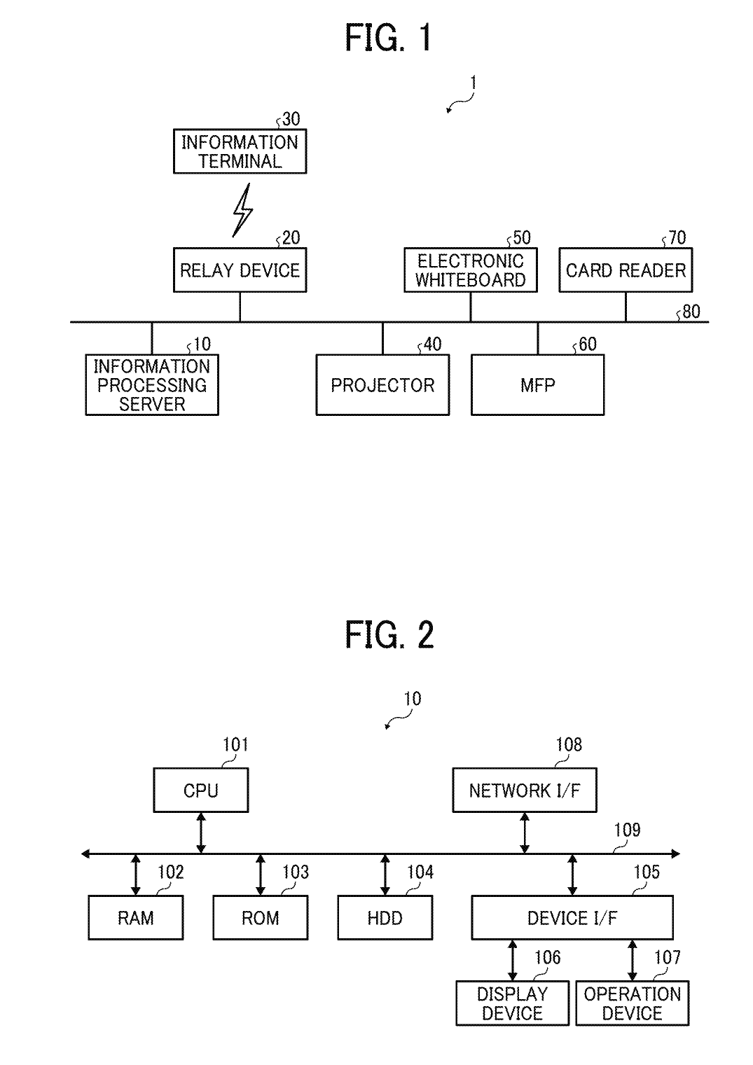

FIG. 1 is a schematic view illustrating an example configuration of an information processing system 1 according to a first embodiment. The information processing system 1 includes an information processing server 10, a relay device 20, an information terminal 30, a projector 40, an electronic whiteboard 50, a multifunction peripheral (MFP) 60, and a card reader 70. The information processing server 10, the relay device 20, the projector 40, the electronic whiteboard 50, the MFP 60 and the card reader 70 are connected to one another via a network 80. The relay device 20 is for example an access point. A range covered by radio wave propagation from the relay device 20 may be referred to as a communication range. The relay device 20 enables one or more information terminals 30, each within the communication range and used by a conference participant, to connect to the network 80 by wireless communication such as Bluetooth (registered trademark) and wireless fidelity (Wi-Fi). The relay device 20, the projector 40, the electronic whiteboard 50, the MFP 60 and the card reader 70 are provided in each conference room, for example.

It should be noted that although in FIG. 1, only a single information terminal 30 is illustrated for the sake of explanatory convenience, there may be any suitable number of information terminals 30, each being connected to the network 80 via the relay device 20. Further, although in FIG. 1, the projector 40, the electronic whiteboard 50, the MFP 60 and the card reader 70 are illustrated as an example of devices included in the information processing system 1, there may be any suitable type and number of devices included in the information processing system 1. In other words, the information processing system 1 could have any suitable configuration, provided that it includes one or more devices that process data accepted from the information processing server 10.

The information processing server 10 is an example of an information processing apparatus that performs, for example, management of conference in its entirety, management (storing or deleting) of data, and output control to devices such as the projector 40, the electronic whiteboard 50, the MFP 60 and the card reader 70. FIG. 2 is a block diagram illustrating an example hardware configuration of information processing server 10 according to the first embodiment. As illustrated in FIG. 2, the information processing server 10 includes a central processing unit (CPU) 101, a random access memory (RAM) 102, a read only memory (ROM) 103, a hard disc drive (HDD) 104, a device interface (I/F) 105 and the network I/F 108, that are connected to one another a bus 109. The device interface 105 is connected to a display device 106 and an operation device 107.

The CPU 101 is a processor, which controls the entire operation of the information processing server 10. The RAM 102 is a high-speed read/write volatile storage medium. The CPU 101 uses the RAM 102 as a work area in processing data. The ROM 103 is a read-only non-volatile storage medium that stores programs such as firmware. The HDD 104 is a read/write non-volatile storage medium that stores an operating system (OS), various control programs, and application programs.

The device interface 105 is an interface that connects each of the display device 106 and the operation device 107 to the bus 109. The display device 106 is a visual user interface that displays various information. Examples of the display device 106 include a liquid crystal display (LCD). The operation device 107 is a user interface, such as a keyboard and a mouse, that accepts user input of information to the information processing server 10. The network interface 108 is an interface that connects the information processing server 10 to the network 80. The network interface 108 could be an interface that complies with any desired system such as an Ethernet (registered trademark) interface.

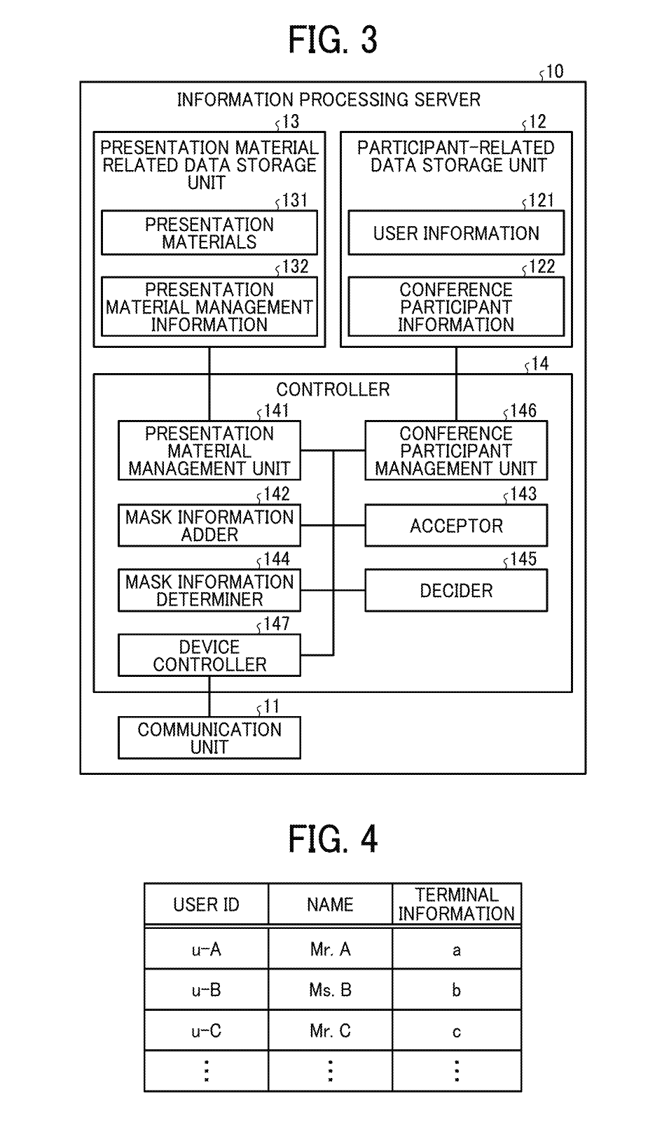

FIG. 3 is a block diagram illustrating an example functional configuration of the information processing server 10 according to the first embodiment. The information processing server 10 includes a communication unit 11, a participant related data storage unit 12, a presentation material related data storage unit 13, and a controller 14. The communication unit 11 controls data exchange between the information processing server 10 and other devices on the network 80.

The participant related data storage unit 12 stores user information 121 and conference participant information 122. The user information 121 is information associating a user (possessor) who is able to access the information processing system 1 with the information terminal 30 possessed by the user.

FIG. 4 illustrates an example of the user information 121 according to the first embodiment. The user information 121 includes a user ID, a name, and a terminal information. The name is a name of a user who is able to access the information processing system 1. The user ID is information for identifying a user. The terminal information is an information indicating the information terminal 30 that a user possesses. Examples of the terminal information include a media access control (MAC) address capable of identifying the information terminal 30. It should be noted that in a case in which a user possesses multiple terminals, one user ID is associated with multiple pieces of the terminal information.

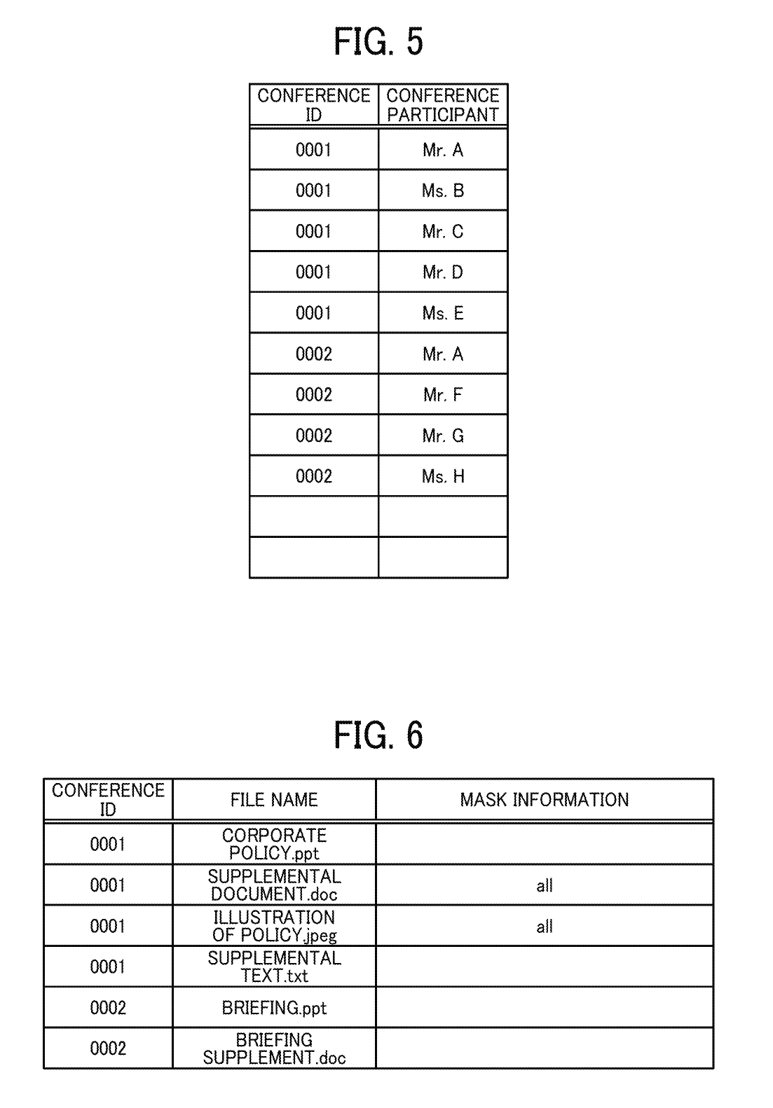

The conference participant information 122 is information associating a conference with a participant or participants. FIG. 5 illustrates an example of the conference participant information 122 according to the first embodiment. The conference participant information 122 includes a conference ID and a conference participant. The conference ID is information for identifying a conference. In this first embodiment, a description is given assuming that the conference ID is assigned to the first conference. The conference participant is someone who participates in a conference identified by the associated conference ID. The conference participant is selected from the users registered in the user information 121. Although FIG. 5 illustrates an example in which a name is registered as the conference participant, the user ID may be registered instead of the name.

The presentation material related data storage unit 13 stores presentation material 131 and presentation material management information 132. The presentation material 131 is material that is used in the first conference. Examples of the presentation material 131 include document data such as a text document and slides, computer-readable data such as image data, video data and audio data. For example, each presentation material 131 is constituted as a file, and identified by a file name.

The presentation material management information 132 associates the presentation material 131 stored in the presentation material related data storage unit 13 with the first conference. Further, the presentation material management information 132 defines whether a person other than a conference participant of the first conference is allowed to view the presentation material 131. The person other than the conference participant of the first conference may be referred to as a “non-participant” hereinafter. In this first embodiment, a description is given of an example case in which, in the presentation material management information 132, information indicating whether a non-participant is allowed to view the material is set on a file-by-file basis.

FIG. 6 illustrates an example of the presentation material management information 132 according to the first embodiment. The presentation material management information 132 includes the conference ID, a file name, and masking information. The conference ID is identification information for identifying a conference. Substantially the same description that is given above of the conference ID in the conference participant information 122 with reference to FIG. 5 applies. The file name is a file name that is assigned to the presentation material 131 stored in the presentation material related data storage unit 13. The masking information is information defining whether to apply a mask to a file designated by the file name. Specifically, ‘all’ is set to the masking information associated with a file that a participant of the second conference should be restricted from viewing. By contrast, no information is set to the masking information associated with a file that a participant of the second conference is allowed to view.

The controller 14 controls the entire operation of the information processing server 10 and an operation of other devices connected to the network 80. The controller 14 includes a presentation material management unit 141, a masking information adder 142, an acceptor 143, a masking information determiner 144, a decider 145, a conference participant management unit 146, and a device controller 147.

The presentation material management unit 141 manages presentation material related data in the presentation material related data storage unit 13. The presentation material management unit 141 stores, in the presentation material management information 132, association between the presentation material 131 stored in the presentation material related data storage unit 13 and a conference in which the presentation material 131 is used.

The masking information adder 142 registers the masking information that is set by the conference participant, in a corresponding record in the presentation material management information 132.

The acceptor 143 accepts, from the information terminal 30 of the conference participant, a designation of the conference ID identifying a conference of which presentation material 131 the conference participant wants to use.

The masking information determiner 144 determines whether there is the masking information that is set for presentation material associated with the conference ID accepted by the acceptor 143. Specifically, the masking information determiner 144 refers to the presentation material management information 132 to determine whether the masking information has been set to a file associated with the designated conference ID.

The decider 145 generates a viewing permission list obtained by extracting a file or files that can be read out depending on a user who possesses the information terminal 30. Further, the decider 145 transmits the generated viewing permission list to the information terminal 30 of the conference participant via the communication unit 11. Specifically, with respect to the conference participant of the second conference, the decider 145 extracts a file name other than a file name to which ‘all’ is set in the masking information in the presentation material management information 132, and lists the extracted file name in the viewing permission list.

A description is given hereinafter of an example in which the acceptor 143 accepts designation of the conference ID 0001 in FIG. 6, i.e., an instruction for reading out the presentation material 131 to the participant of the second conference who did not attend the first conference. In an example of FIG. 6, four files respectively having file names ‘Corporate Policy.ppt’, ‘Supplemental Document.doc’, ‘Illustration of Policy.jpg’ and ‘Supplemental Text.txt’ are associated with the conference ID 0001. From these four files, the presentation material management unit 141 extracts, as the viewing permission list, ‘Corporate Policy.ppt’ and ‘Supplemental Text.txt’ for which ‘all’ is not set in the masking information. In a case in which the acceptor 143 accepts an instruction for reading out the presentation material 131 to the participant of the first conference, a file name associated with the designated conference ID is listed in the viewing permission list, regardless of the masking information.

The conference participant management unit 146 manages conference participant data in the participant related data storage unit 12. The conference participant management unit 146 registers a conference ID and a conference participant in the conference participant information 122 when the first conference is held. For example, when a participant of the first conference causes the card reader 70 that is placed at a conference room to read an ID card that the participant possesses, the conference participant management unit 146 registers information indicating the conference participant in the conference participant information 122 based on the user ID contained in the ID card and information identifying the conference room, both being received from the card reader 70.

The device controller 147 controls, via the communication unit 11, operations of devices such as the relay device 20, the information terminal 30, the projector 40, the electronic whiteboard 50, the MFP 60, and the card reader 70, each being connected to the network 80. For example, the device controller 147 controls image projection to the projector 40 or image display to the electronic whiteboard 50. The device controller 147 also controls information to be displayed on the information terminal 30. Further, the device controller 147 gives an instruction for a scan operation to the MFP 60 via the communication unit 11, and stores, in the presentation material related data storage unit 13, data obtained by scanning, as the presentation material 131. Furthermore, when the card reader 70 reads an ID card of each user, the device controller 147 sends information that is read out by the card reader 70 to the conference participant management unit 146.

Moreover, the device controller 147 provides the information terminal 30 with the presentation material 131. Specifically, the device controller 147 sends, to the presentation material management unit 141, terminal information of the information terminal 30 from which a request for the presentation material 131 is received, to acquire the viewing permission list. The device controller 147 acquires the presentation material 131 from the presentation material related data storage unit 13 according to the viewing permission list. The device controller 147 transmits the acquired presentation material 131 to the information terminal 30 via the communication unit 11.

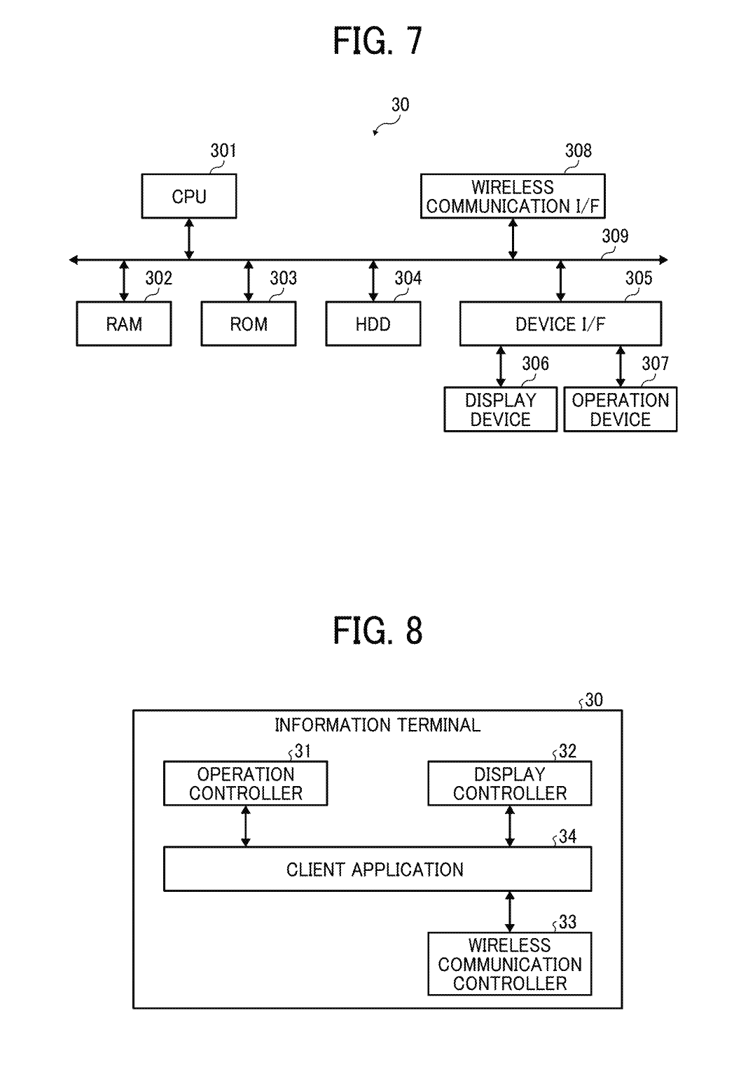

Hereinafter, a description is given of a configuration of the information terminal 30 used in the information processing system 1. FIG. 7 is a block diagram illustrating an example hardware configuration of the information terminal 30 according to the first embodiment. Examples of the information terminal 30 include a portable multifunction device (smart device) such as a smartphone, a tablet, and a mobile personal computer. As illustrated in FIG. 7, the information terminal 30 includes a CPU 301, a RAM 302, a ROM 303, an HDD 304, a device interface 305, and a wireless communication interface 308, that are connected to one another via a bus 309. The device interface 305 is connected to a display device 306 and an operation device 307.

The CPU 301 is a processor, which controls the entire operation of the information terminal 30. The RAM 302 is a high-speed read/write volatile storage medium. The CPU 301 uses the RAM 302 as a work area in processing data. The ROM 303 is a read-only non-volatile storage medium that stores programs such as firmware. The HDD 304 is a read/write non-volatile storage medium that stores an OS, various control programs, and application programs.

The device interface 305 is an interface that connects each of the display device 306 and the operation device 307 to the bus 309. The display device 306 is a visual user interface that displays various information. Examples of the display device 306 include an LCD. The operation device 307 is a user interface, such as a keyboard and a mouse, that accepts user input of information to the information terminal 30. In a case in which the information terminal 30 is a smartphone or a tablet, the operation device 307 and the display device 306 are integrally constituted as a touch panel. The wireless communication interface 308 is an interface that enables the information terminal 30 to communicate wirelessly with the relay device 20.

FIG. 8 is a block diagram illustrating an example functional configuration of the information terminal 30 according to the first embodiment. Although in FIG. 8, functions related to the first embodiment are mainly illustrated for the sake of explanatory convenience, the information terminal 30 may include other additional functions. As illustrated in FIG. 8, the information terminal 30 includes an operation controller 31, a display controller 32, a wireless communication controller 33, and a client application 34.

The operation controller 31 acquires operation signals input via the operation device 307, and inputs the operation signals to a module, such as the client application 34, that runs on the information terminal 30. In other words, it can be considered that the operation controller 31 has a function of accepting a user operation.

The display controller 32 performs control for displaying, on the display device 306, various information concerning the information terminal 30, such graphical user interfaces (GUI) of the client application 34.

The wireless communication controller 33 controls communications with other devices via the wireless communication interface 308. For example, the wireless communication controller 33 acquires data input via the wireless communication interface 308, and transmits data to other devices via the wireless communication interface 308.

The client application 34 is a software module that provides various functions in the information terminal 30. The client application 34 includes software programs, respectively corresponding to the various functions. A dedicated application for using the conference system is also included in the client application 34.

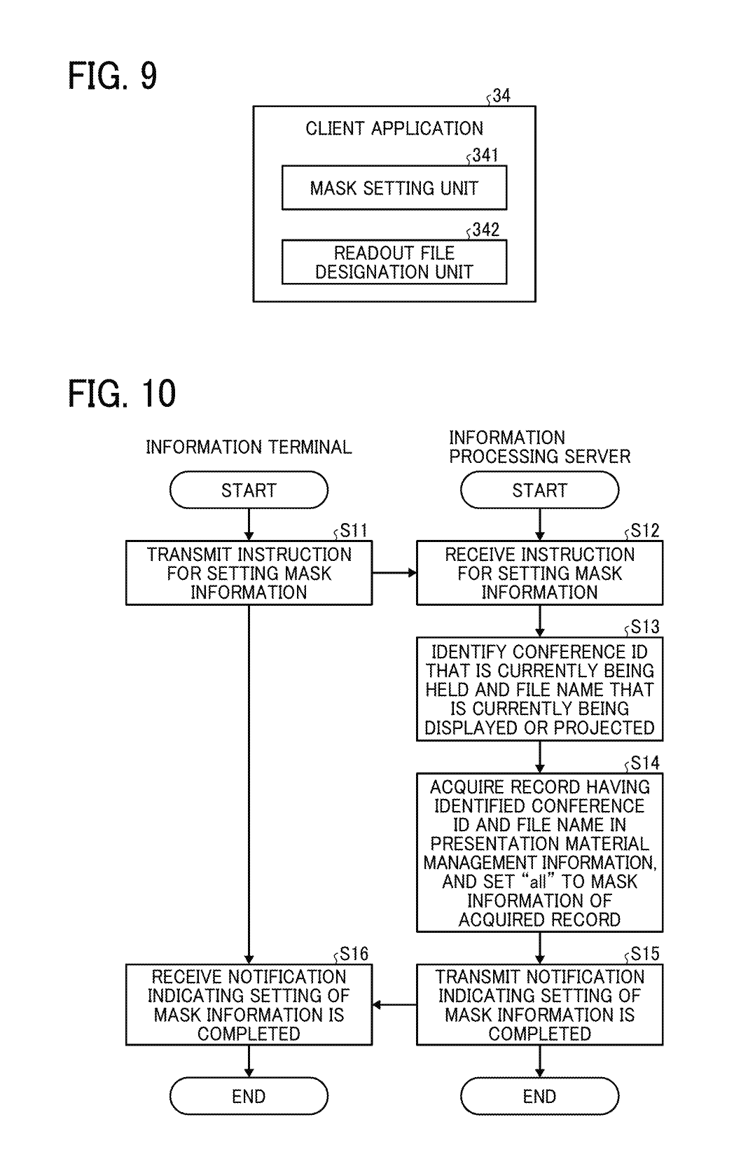

FIG. 9 illustrates an example of functions provided by the client application 34 according to the first embodiment. Although in FIG. 9, only the functions related to the first embodiment are illustrated for the sake of explanatory convenience, the functions provided by the client application 34 are not limited thereto. As illustrated in FIG. 9, the client application 34 includes a mask setting unit 341 and a readout file designation unit 342.

The mask setting unit 341 sets masking information to the presentation material 131 in the presentation material related data storage unit 13 of the information processing server 10. Specifically, the mask setting unit 341 gives, to the information processing server 10, an instruction of a masking range to be applied to the presentation material 131 used in the first conference, the masking range indicating a range that the participant of the second conference should be restricted from viewing.

When reading out the presentation material 131 from the presentation material related data storage unit 13, the readout file designation unit 342 requests the information processing server 10 for the viewing permission list with the designation of the conference ID. At this time, the readout file designation unit 342 designates whether a user is a participant or a non-participant of the first conference to enable a user who participates in both of the first conference and the second conference to view the same presentation material 131 as viewed by other participants of the second conference. Further, the readout file designation unit 342 selects the presentation material 131 to be viewed from the viewing permission list acquired from the information processing server 10. Further, the readout file designation unit 342 gives an instruction for displaying the selected presentation material 131 to the information processing server 10. It should be noted that the readout file designation unit 342 is capable of selecting a device, i.e., the information terminal 30, the projector 40, or the electronic whiteboard 50, on which the presentation material 131 is to be displayed.

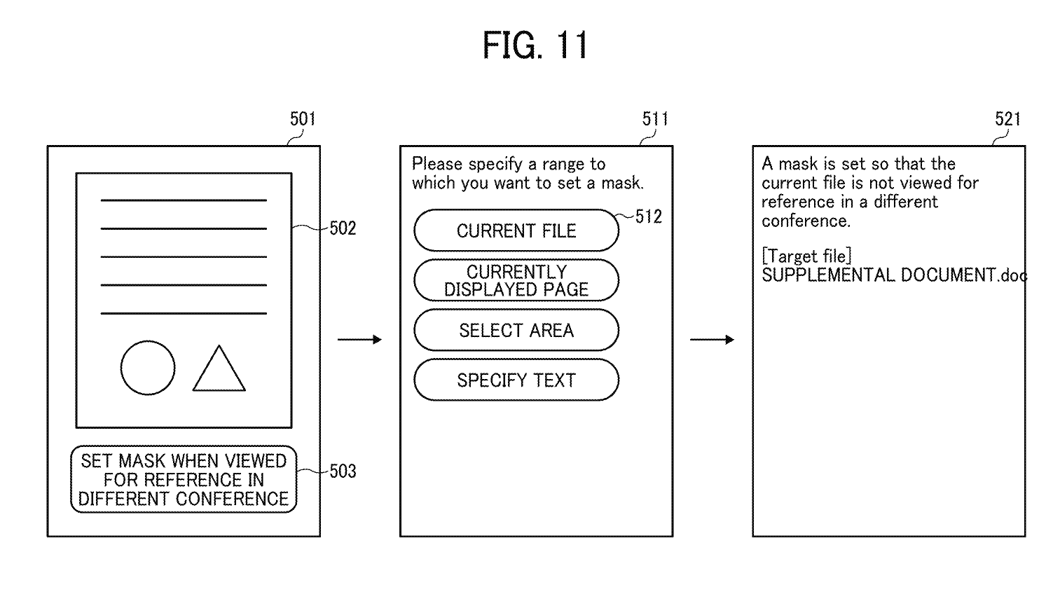

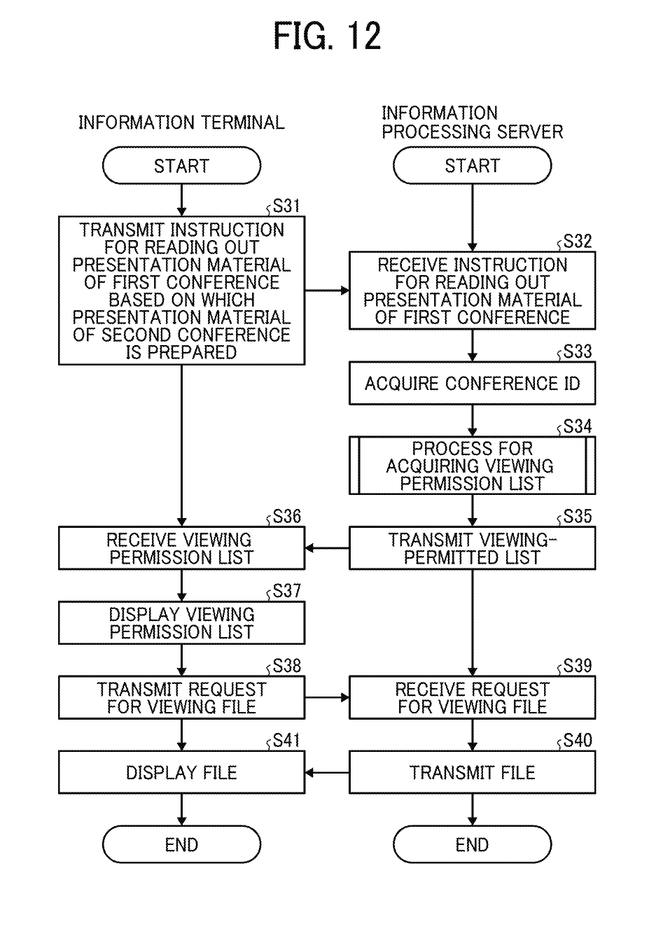

Hereinafter, a description is given of an operation performed by the information processing system 1. FIG. 10 is a flowchart illustrating steps in an operation of setting the masking information in the presentation material management information 132 according to the first embodiment. FIG. 11 illustrates an example of a display screen displayed on the information terminal 30 when generating the masking information according to the first embodiment.

In this embodiment, a description is given assuming that a file that is projected on the projector 40 or displayed on the electronic whiteboard 50 in the first conference is also displayed on the information terminal 30 that each participant of the first conference possesses. For example, a file display screen 501 as illustrated in FIG. 11 is displayed on the display device 306 of the information terminal 30 of the conference participant. The file display screen 501 includes a file display area 502 and a SET MASK WHEN VIEWED FOR REFERENCE IN DIFFERENT CONFERENCE key 503. In the file display area 502, the content of a file is displayed. The SET MASK WHEN VIEWED FOR REFERENCE IN DIFFERENT CONFERENCE key 503 enables the masking information setting to the file displayed in the file display area 502.

In response to selection of the SET MASK WHEN VIEWED FOR REFERENCE IN DIFFERENT CONFERENCE key 503 by the conference participant, the mask setting unit 341 displays a masking range designation screen 511 as illustrated in FIG. 11 on the display device 306. The masking range designation screen 511 includes a CURRENT FILE key 512 that accepts selection of a file currently being displayed on the file display screen 501 as a range to be masked. When the conference participant selects the CURRENT FILE key 512 on the masking range designation screen 511, the mask setting unit 341 sends, to the information processing server 10, an instruction for setting the masking information that masks the file currently being displayed on the file display screen 501 (S11).

In response to receiving the instruction for setting the masking information (S12), the masking information adder 142 of the information processing server 10 identifies the conference ID of a conference that the conference participant is attending and a file name of a file that is being displayed on the information terminal 30 or the electronic whiteboard 50 or projected on the projector 40 (S13). For example, to acquire the conference ID, the masking information adder 142 refers to, via the conference participant management unit 146, the user information 121 and the conference participant information 122 based on the terminal information of the information terminal 30 from which the instruction is received. Further, to acquire the file name, the masking information adder 142 inquires the device controller 147 of a file being transmitted to the information terminal 30, for example.

Subsequently, the masking information adder 142 of the information processing server 10 acquires a record having the identified conference ID and file name from the presentation material management information 132, and sets ‘all’ to the masking information of the acquired record (S14). Upon completion of the masking information setting, the communication unit 11 transmits, to the information terminal 30, a notification indicating that the setting of the masking information has been completed (S15). The information terminal 30 receives the notification indicating that the setting of the masking information has been completed (S16). A mask setting completion notification screen 521 as illustrated in FIG. 11 is displayed on the display device 306 of the information terminal 30. On the mask setting completion notification screen 521, a target file name to which a mask is set is displayed. Then, the operation ends.

For example, FIG. 6 illustrates an example of the presentation material management information 132 in which ‘Supplemental Document.doc’ and ‘Illustration of Policy.jpg’ associated with the conference ID 0001 are selected as masking targets with the operation as described heretofore.

A description is given above of an example in which the masking information is set to a file that is being projected on the projector 40 or displayed on the electronic whiteboard 50. However, this is just an example, and alternatively desired presentation material 131 stored in the presentation material related data storage unit 13 may be selected to set the masking information to the selected presentation material 131 individually.

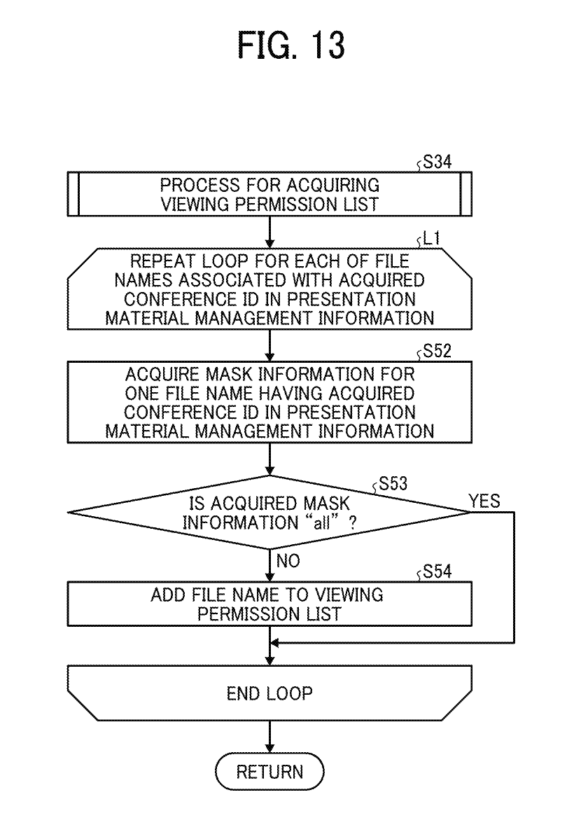

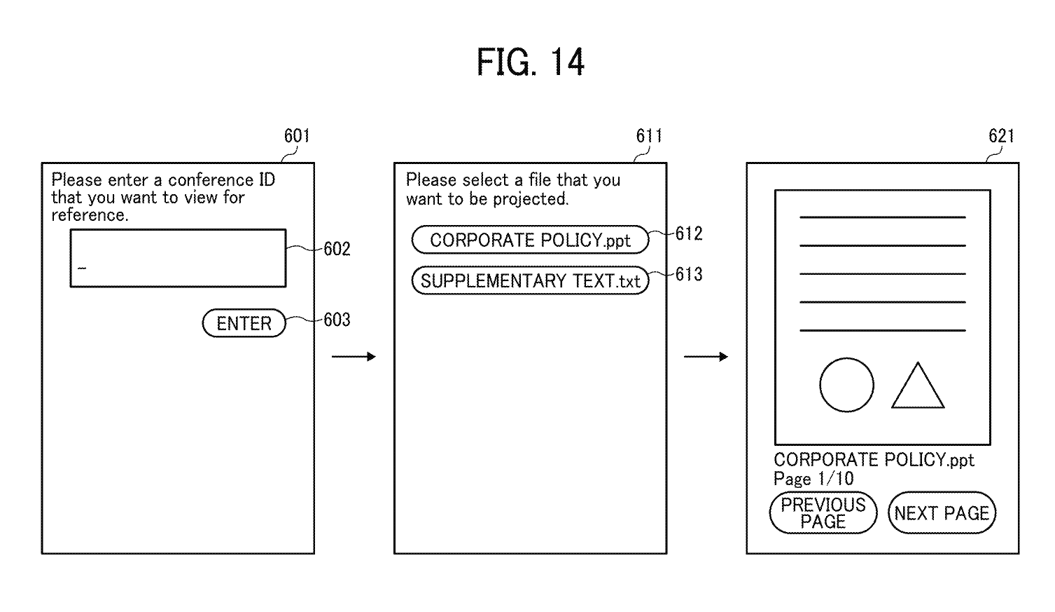

A description is given hereinafter of an operation of displaying the presentation material 131 in the second conference, with reference to FIGS. 12-14. FIG. 12 is a flowchart illustrating steps in an operation of transmitting the presentation material 131 according to the first embodiment. FIG. 13 is a flowchart illustrating steps in an operation of acquiring the viewing permission list according to the first embodiment. FIG. 14 illustrates an example of a display screen displayed on the information terminal 30 in a transmission process of presentation materials.

First, a conference ID input screen 601 as illustrated in FIG. 14 is displayed on the display device 306 of the information terminal 30. The conference ID input screen 601 includes a conference ID entry field 602 and an ENTER key 603. A participant of the second conference enters, in the conference ID entry field 602, a conference ID of a conference that the participant wants to refer, and thereafter presses the ENTER key 603. Based on this user input, the readout file designation unit 342 of the information terminal 30 transmits, to the information processing server 10 via the wireless communication controller 33, an instruction for reading out the presentation material 131 of the first conference based on which the presentation material 131 of the second conference is to be generated (S31). The instruction contains the conference ID of the first conference.

The acceptor 143 of the information processing server 10 receives the instruction (S32). The decider 145 acquires the conference ID from the instruction (S33), and acquires the viewing permission list (S34).

With reference to FIG. 13, a description is given of the acquisition of the viewing permission list performed at S34 in FIG. 12. The masking information determiner 144 and the decider 145 performs a loop L1 from S52 to S54 for each of files respectively identified by file names associated with the acquired conference ID. A description is given hereinafter assuming that the presentation material 131 is viewed in the second conference and the instruction includes information that instructs reading out the masked presentation material 131, for example.

First, for a given one of the file names that are associated with the acquired conference ID in the presentation material management information 132, the masking information determiner 144 acquires the masking information (S52). Subsequently, the masking information determiner 144 determines whether the acquired masking information is ‘all’ (S53). In a case in which the acquired masking information is not ‘all’ (S53: NO), the decider 145 adds the file name as the current determination target to alternatives in the viewing permission list (S54). After S54, or in a case in which the acquired masking information is ‘all’ (S53: YES), the loop L1 for the file as the current determination target ends. When the loop L1 from S52 to S54 is performed for each and every file name associated with the acquired conference ID, the acquisition of the viewing permission list is completed.

Referring again to the flowchart of FIG. 12, the communication unit 11 transmits the viewing permission list to the information terminal 30 (S35). In response to receiving the viewing permission list (S36), the readout file designation unit 342 of the information terminal 30 displays the viewing permission list on the display device 306 (S37).

For example, the viewing permission list is displayed on the display device 306 in a form of a viewing permission list display screen 611 as illustrated in FIG. 14. The viewing permission list display screen 611 includes keys 612 and 613 of the file names selected by the above operation. According to an example in which the conference ID 0001 in the presentation material management information 132 of FIG. 6, a ‘Corporate Policy.ppt’ key 612 and a ‘Supplemental Text.txt” key 613’, as ‘all’ is not set to the masking information associated with these file names.

When the participant of the second conference selects the file name key 612 or the file name key 613 on the viewing permission list display screen 611, the readout file designation unit 342 transmits, to the information processing server 10, a request for viewing the selected file (S38).

In response to receiving the viewing request (S39), the device controller 147 of the information processing server 10 extracts a file corresponding to the file name contained in the viewing request from the presentation material related data storage unit 13. Further, the device controller 147 transmits the extracted file to the information terminal 30 via the communication unit 11 (S40). Thus, the file is displayed on the display device 306 of the information terminal 30 (S41). In response to selecting the ‘Corporate Policy.ppt’ key 612 on the viewing permission list display screen 611 at S38, the ‘Corporate Policy.ppt’ file is displayed on a file display screen 621, as illustrated in FIG. 14.

Although in the above a description is given of an example in which the file is displayed on the display device 306 of the information terminal 30, the file may be displayed on a different device such as the projector 40 and the electronic whiteboard 50, according to settings for specifying a device that is to display the file. Such settings may be configured on the viewing permission list display screen 611. Then, the operation ends.

As illustrated in FIGS. 12 and 13, the presence of the masking information is checked when, reading out, in the second conference, the presentation material 131 that was used in the first conference. By contrast, there is no need to check the presence of the masking information when reading out the presentation material 131 of the first conference in the first conference, and all presentation materials are read out.

As described heretofore, according the first embodiment, the presentation material that should not be allowed to be viewed in the second conference is selected on a file-by-file basis from among the presentation material 131 used in the first conference. The selection result is recorded as the masking information in the presentation material management information 132 that associates the conference ID with file names. Further, in the second conference, from among the files associated with the selected conference ID, only a file or files to which no masking information is set are added to the viewing permission list. Thus, only the file listed in the viewing permission list is displayed on the information terminal 30 of the participant of the second conference. Alternatively, only the file listed in the viewing permission list is displayed on the electronic whiteboard 50 that the participant of the second conference views, or projected on the projector 40 that the participant of the second conference views. This enables restricting the participant of the second conference, who did not participate in the first conference, from viewing the file that is viewed by the participant of the first conference. In addition, the file or files transmitted to the participant of the second conference are file or files that are used in the first conference, and thereby no file is generated for the second conference. Accordingly, this prevents a size of the presentation material 131 stored in the information processing system 1 from becoming too large. In other words, the first embodiment enables specifying a range that can be referred to in the second conference without increasing the size of the presentation material stored in the information processing server 10.

### Second Embodiment

As described heretofore, according to the first embodiment, the presentation material that should not be allowed to be viewed in the second conference is selected on a file-by-file basis from among the presentation material 131 used in the first conference. A description is given hereinafter of a second embodiment in which restriction for viewing in the second conference is imposed on a page-by-page basis in the file.

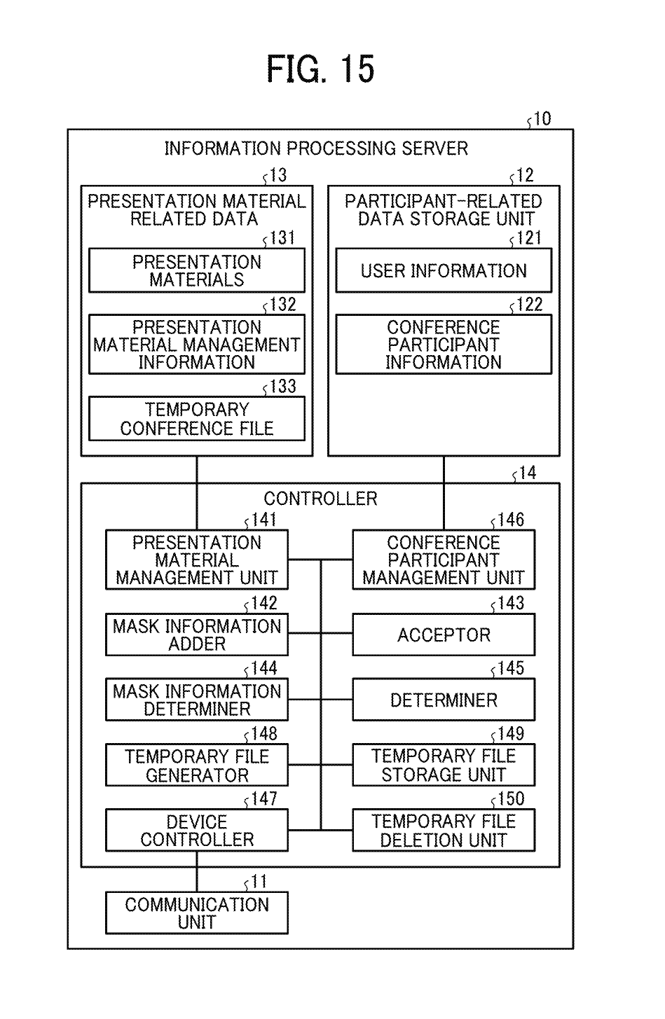

FIG. 15 is a block diagram illustrating an example functional configuration of the information processing server 10 according to the second embodiment. In the information processing server 10 according to the second embodiment, the presentation material related data storage unit 13 further stores a temporary presentation file 133. The temporary presentation file 133 is a copy of a masking target file, to which a mask is applied on a page-by-page basis. The temporary presentation file 133 is an example of a temporary file described in the appended claims.

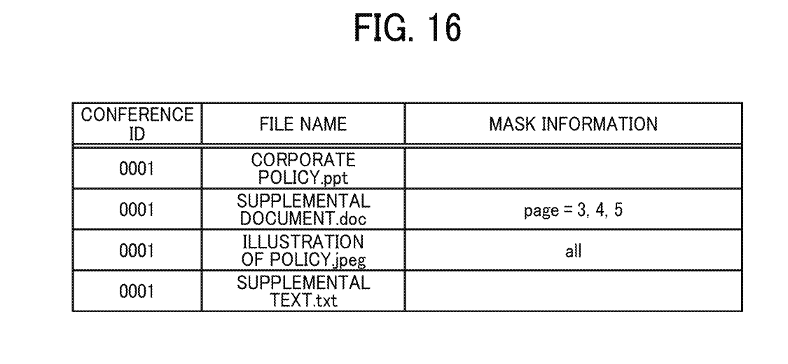

Further, in the masking information of the presentation material management information 132 stored in the presentation material related data storage unit 13, a range to be masked is set on a file-by-file basis or a page-by-page basis. FIG. 16 illustrates an example of the presentation material management information 132 according to the second embodiment. As illustrated in FIG. 16, in the management information of the presentation material management information 132 includes a page-by-page basis masking information in addition to a file-by-file basis masking designation. To designate a mask on a page-by-page basis, page information, such as ‘page=3, 4, 5’, indicating one or more pages to be masked, is designated in the masking information.

In the second embodiment, the controller 14 further includes a temporary file generator 148, a temporary file storage unit 149, and a temporary file deletion unit 150. When transmitting the presentation material 131 to other devices such as the information terminal 30, the temporary file generator 148 generates the temporary presentation file 133 to which a mask is applied on a page-by-page basis. The temporary file storage unit 149 stores the temporary presentation file 133 generated by the temporary file generator 148 in the presentation material related data storage unit 13. The temporary file deletion unit 150 deletes the temporary presentation file 133 from the presentation material related data storage unit 13 after the second conference is over.

In the second embodiment, the same reference numbers are allocated to elements (members or components) having the same function as those of the first embodiment, and redundant description thereof is omitted. Further, the configuration of the information terminal 30 according to the second embodiment is the same or substantially the same as that of the first embodiment. Therefore, redundant description thereof is omitted below. Furthermore, the hardware configurations of the information processing server 10 and the information terminal 30 according to the second embodiment are the same or substantially the same as those of the first embodiment. Therefore, redundant description thereof is omitted below.

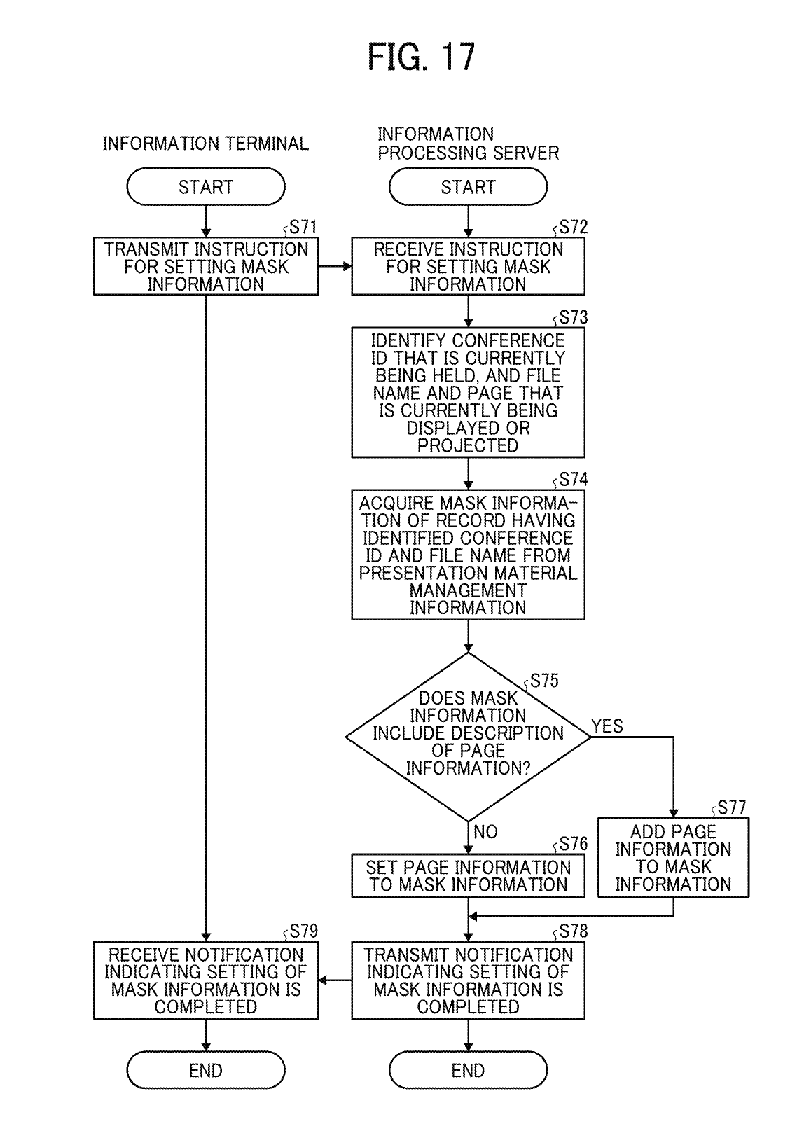

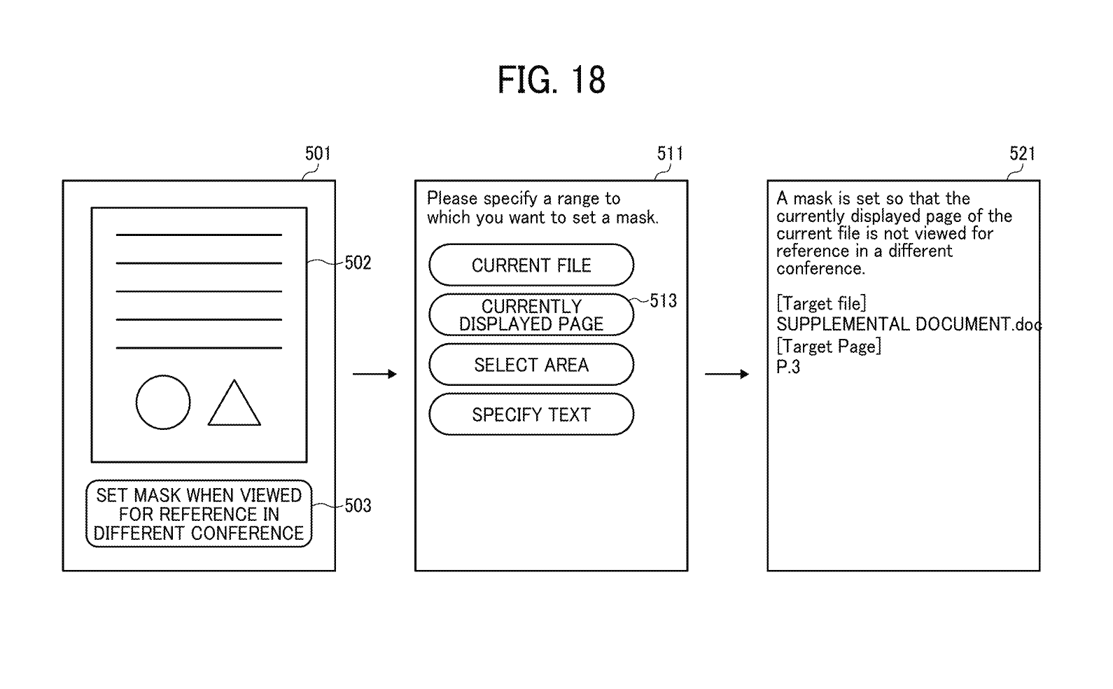

Hereinafter, a description is given of an operation performed by the information processing system 1 according to the second embodiment. FIG. 17 is a flowchart illustrating steps in an operation of setting the masking information according to the second embodiment. FIG. 18 illustrates an example of a setting screen for setting masking information on the information terminal 30 according to the second embodiment.

As illustrated in FIG. 18, also in the second embodiment, the file display screen 501 is displayed on the display device 306 of the information terminal 30. The same file as a file that is projected on the projector 40 or displayed on the electronic whiteboard 50 is displayed in the file display area 502 of the file display screen 501. In response to selection of the SET MASK WHEN VIEWED FOR REFERENCE IN DIFFERENT CONFERENCE key 503 by the conference participant on the file display screen 501 as illustrated in FIG. 18, the mask setting unit 341 of the information terminal 30 displays the masking range designation screen 511 as illustrated in FIG. 18 on the display device 306. When the conference participant selects a CURRENTLY DISPLAYED PAGE key 513 on the masking range designation screen 511, the mask setting unit 341 sends, to the information processing server 10, an instruction for setting the masking information to a page that has been displayed in the file display area 502 of the file display screen 501 (S71).

In response to receiving the instruction for setting the masking information (S72), the masking information adder 142 of the information processing server 10 identifies the conference ID of a conference that a user who possesses the information terminal 30 is attending (S73). Further, the masking information adder 142 identifies a file name and a page that is being displayed on the information terminal 30 or the electronic whiteboard 50 or projected on the projector 40 (S73). Subsequently, the masking information adder 142 acquires masking information of a record having the identified conference ID and file name from the presentation material management information 132 (S74).

The masking information adder 142 determines whether there is a description of the page information in the acquired masking information (S75). In a case in which there is no description of the page information in the masking information (S75: NO), the masking information adder 142 sets the page information that is identified at S73 to the masking information (S76). For example, page 3 of a given file is a masking target, ‘page=3’ is set to the masking information.

By contrast, in a case in which the masking information includes description of the page information (S75: YES), the masking information adder 142 adds the page information that is identified at S73 to the masking information (S77). For example, in a case in which ‘page=1’ has been already set in the masking information of a given file and page 3 is to be further added as the masking target, the masking information becomes ‘page=1, 3’.

Upon completion of the masking information setting, the communication unit 11 transmits, to the information terminal 30, a notification indicating that the setting of the masking information has been completed (S78). The information terminal 30 receives the notification indicating that the setting of the masking information has been completed (S79). The mask setting completion notification screen 521 as illustrated in FIG. 18 is displayed on the display device 306 of the information terminal 30. On the mask setting completion notification screen 521, a target file name and a target page to which a mask is set are displayed. Then, the operation ends.

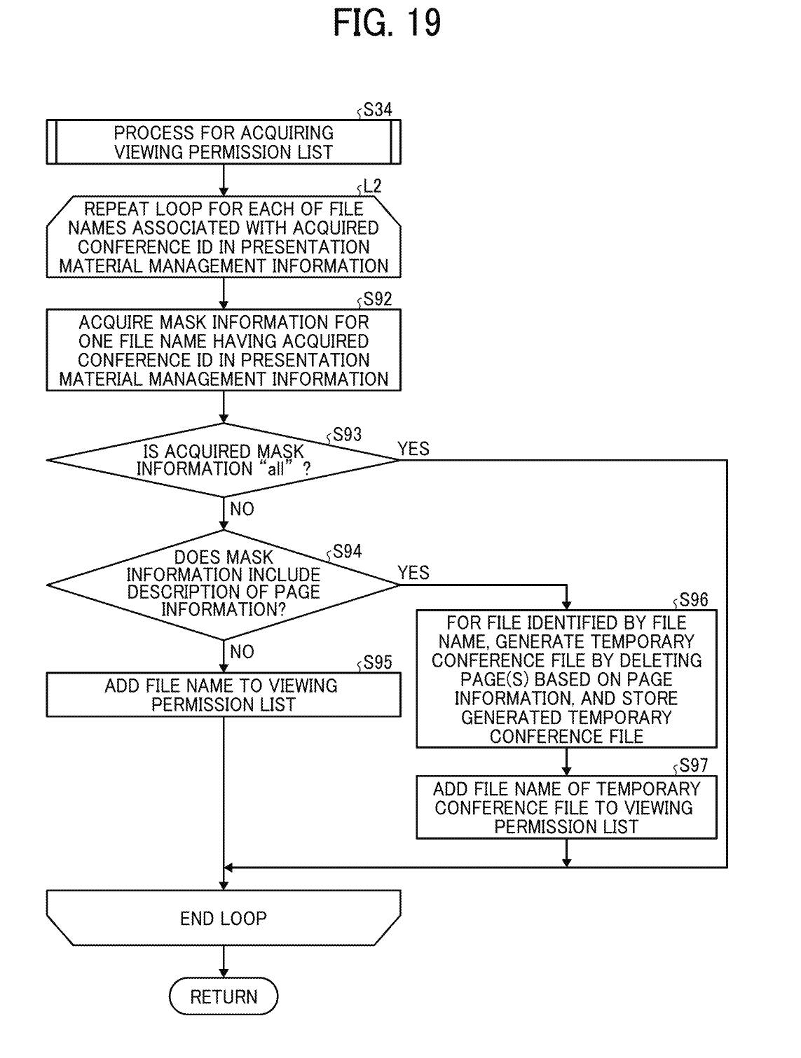

The presentation material 131 is displayed in the second conference in substantially the same manner as described above with reference to FIG. 12, except for the process of acquiring the viewing permission list. Accordingly, a description is given hereinafter of the process of acquiring the viewing permission list according to the second embodiment. FIG. 19 is a flowchart illustrating steps in an operation of acquiring the viewing permission list according to the second embodiment.

Upon acquiring the conference ID (S33 of FIG. 12), the information processing server 10 performs a loop L2 from S92 to S97 for each of file names associated with the acquired conference ID in the presentation material management information 132. A description is given hereinafter assuming that the presentation material 131 is viewed in the second conference and the instruction acquired at S32 of FIG. 12 includes information that instructs reading out the masked presentation material 131, for example.

First, for a given one of the file names that are associated with the acquired conference ID in the presentation material management information 132, the masking information determiner 144 acquires the masking information (S92). Subsequently, the masking information determiner 144 determines whether the acquired masking information is ‘all’ (S93). In a case in which the acquired masking information is not ‘all’ (S93: NO), the masking information determiner 144 determines whether there is a description of the page information in the acquired masking information (S94).

In a case in which there is no description of the page information in the masking information (S94: NO), the decider 145 adds the file name as the current determination target to alternatives in the viewing permission list (S95). By contrast, in a case in which there is a description of the page information in the masking information (S94: YES), the temporary file generator 148 generates the temporary presentation file 133 that is obtained by deleting a page or pages described in the page information from the file specified by the file name (S96). Further, the temporary file storage unit 149 stores the generated temporary presentation file 133 in the presentation material related data storage unit 13 (S96). In other words, the temporary presentation file 133, which is a file obtained by applying a mask to a copy of the target file, is stored in the presentation material related data storage unit 13. Next, the decider 145 adds a name of the generated temporary presentation file 133 to the viewing permission list (S97).

After S97, or in a case in which the acquired masking information is ‘all’ (S93: YES), the loop L2 for the current determination target file ends. The processing from S92 to S97 is performed for each of the file names associated with the acquired conference ID.

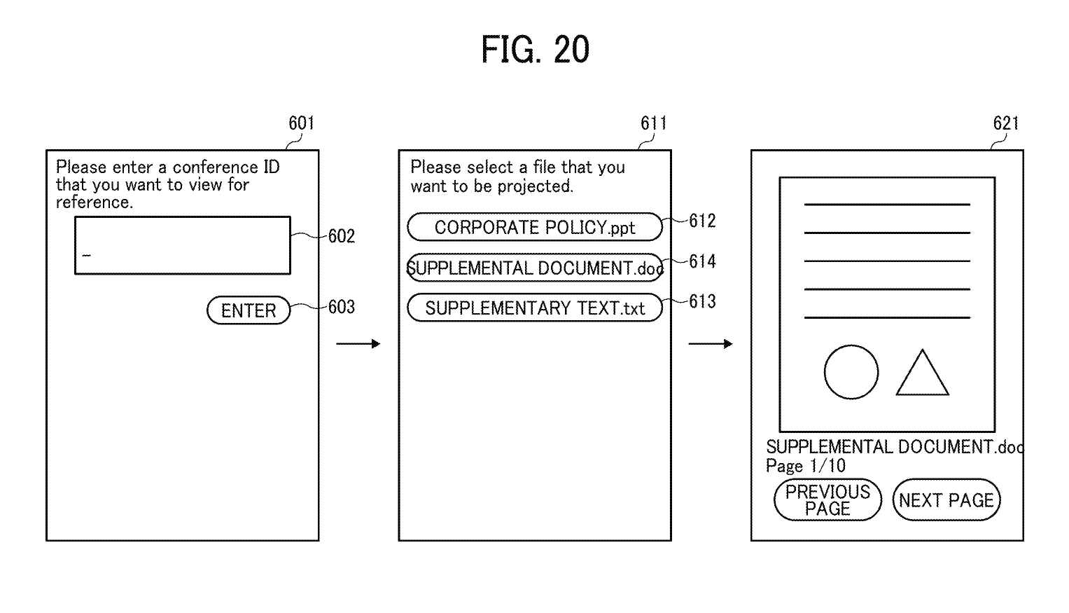

Hereinafter, a description is given of a display process by the information terminal 30 in a transmission process of the presentation materials, assuming that the viewing permission list is generated based on the presentation material management information 132 illustrated in FIG. 16. FIG. 20 illustrates an example of a display screen displayed on the information terminal 30 in a transmission process of presentation materials according to the second embodiment.

As illustrated in FIG. 20, when the information terminal 30 accepts an entry of the conference ID in the conference ID entry field 602 on the conference ID input screen 601, and thereafter accepts selection of the ENTER key 603, the viewing permission list display screen 611 is displayed on the display device 306 of the information terminal 30. The viewing permission list display screen 611 includes the ‘Corporate Policy.ppt’ key 612, a ‘Supplemental Document.doc’ key 614, and the ‘Supplemental Text.txt’ key 613. In this example, a file associated with the ‘Supplemental Document.doc’ key 614 is the temporary presentation file 133 in which pages 3 to 5 are masked. Accordingly, in response to selection of the ‘Supplemental Document.doc’ key 614, ‘Supplemental Document.doc’ in the temporary presentation file 133 is read out, rather than ‘Supplemental Document.doc’ in the presentation material 131. The file display screen 621 of FIG. 20 illustrates a case in which ‘Supplemental Document.doc’ in the temporary presentation file 133 is read out.

As described heretofore, according to the second embodiment, the portion that should not be allowed to be viewed in the second conference is selected on a page-by-page basis from among the presentation material 131. The selection result is recorded as the masking information in the presentation material management information 132 that associates the conference ID with file names. In the second conference, from among the files associated with the selected conference ID, with respect to a file for which a mask is set on a page-by-page basis, the temporary presentation file 133 is generated by masking the pages of the file based on the masking information. Further, the temporary presentation file 133 is added to the viewing permission list. The participant of the second conference selects a desired file for viewing from the viewing permission list. Even in a case in which one file used in the first conference contains a page that the second conference participant should be allowed to view and a page that the second conference participant should be restricted from viewing, the second embodiment enables disclosure of only the page that the second conference participant should be allowed to view.

Further, because the temporary presentation file 133 is deleted after the second conference is over, a size of the presentation material 131 stored in the information processing system 1 is prevented from becoming too large.

### Third Embodiment

A description is given heretofore of the second embodiment, in which a part of presentation material used in the first conference that should be restricted for viewing in the second conference is specified on a page-by-page basis. Hereinafter, a description is given of a third embodiment, in which an area that should not be allowed to be viewed is specified in a file.

The information processing server 10 according to the third embodiment has substantially the same configuration as that of the information processing server 10 according to the second embodiment, except that the third embodiment specifies area designation information. More specifically, according to the third embodiment, the area designation information that specifies an area to be masked within a page can be specified in the masking information of the presentation material management information 132 stored in the presentation material related data storage unit 13, in addition to the file-by-file basis and the page-by-page basis masking specification.

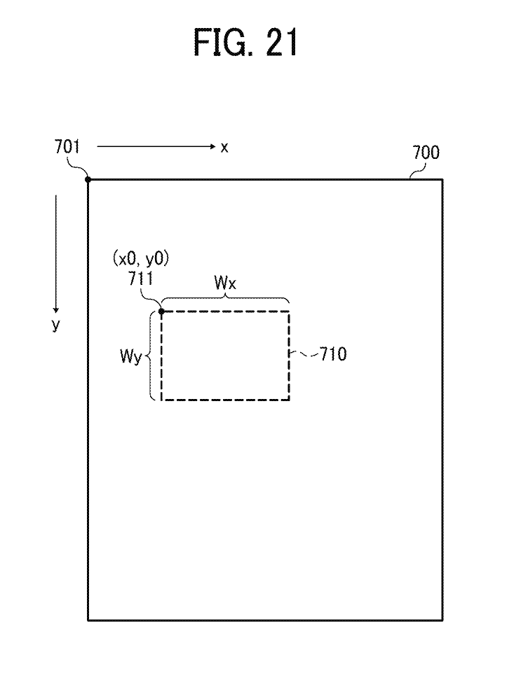

FIG. 21 illustrates designation of an area in a file according to the third embodiment. For example, an area 710 to be masked is specified using a coordinate system, in which an upper-left corner of each page 700 that constitutes a file is an origin 701, a direction from the upper-left corner to an upper-right corner is an x-axis positive direction, and a direction from the upper-left corner to a lower-left corner is a y-axis positive direction. The area 710 may be specified in any suitable format. For example, in this embodiment, ‘page=n & range=(x0, y0, Wx, Wy)’ is used for specifying a rectangular area. In this example, n indicates a number of page that contains an area to be masked in a file, x0 indicates an x-coordinate of a starting position of a masking area, y0 indicates a y-coordinate of the starting position, Wx indicates a width in an x-axis direction, and Wy indicates a width in a y-axis direction. Further, it is assumed that the starting position is an upper-left corner 711 of the rectangular area 710. It should be noted that although this format specifies the rectangular area 710, the area 710 may be specified in any other suitable format such as a circle, an ellipse, or a free-drawn area.

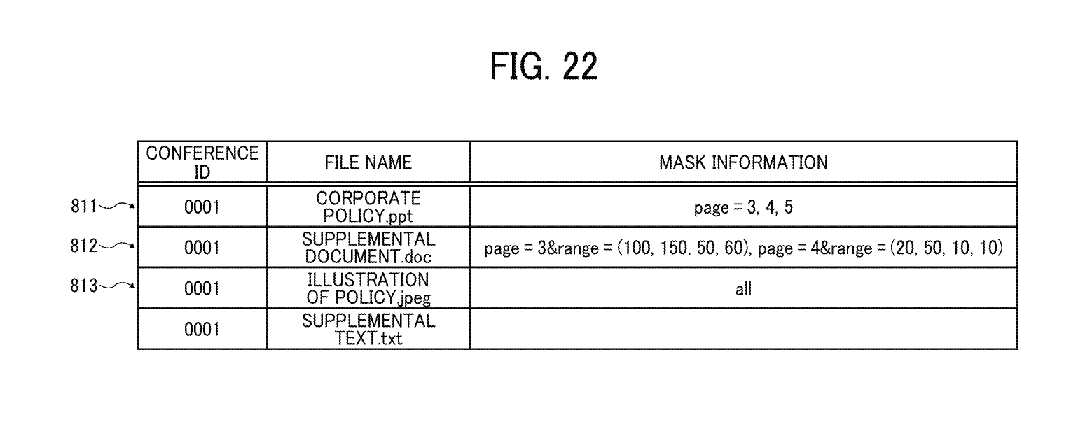

FIG. 22 illustrates an example of the presentation material management information 132 according to the third embodiment. FIG. 22 illustrates an example in which the area designation information is set in the masking information of a record 812. Specifically, the masking information of the record 812 specifies that in page 3 of ‘Supplemental Document.doc’, an area whose x-axis width is 50 and y-axis width is 60 with reference to the starting position (100, 150) is to be masked. Further, this masking information specifies that in page 4 of ‘Supplemental Document.doc’, an area whose x-axis width is 10 and y-axis width is 10 with reference to the starting position (20, 50) is also to be masked. Further, the masking information of a record 811 specifies a mask on a page-by-page basis. Furthermore, the masking information of a record 813 specifies a mask on a file-by-file basis.

In a case in which the masking information includes the area designation information, the temporary file generator 148 generates an image file obtained by converting each page of the corresponding file in the presentation material 131 into an image. Further, the temporary file generator 148 removes an area specified by the area designation information from the image file to generate the temporary presentation file 133. The temporary file storage unit 149 stores this temporary presentation file 133 in the presentation material related data storage unit 13.

The configuration according to the third embodiment is the same or substantially the same as that of the first embodiment and the second embodiment, expect for the area designation information as described above. Therefore, redundant description is omitted below. Further, the configuration of the information terminal 30 according to the third embodiment is the same or substantially the same as that of the first embodiment. Therefore, redundant description thereof is omitted below. Furthermore, the hardware configurations of the information processing server 10 and the information terminal 30 according to the third embodiment are the same or substantially the same as those of the first embodiment. Therefore, redundant description thereof is omitted below.

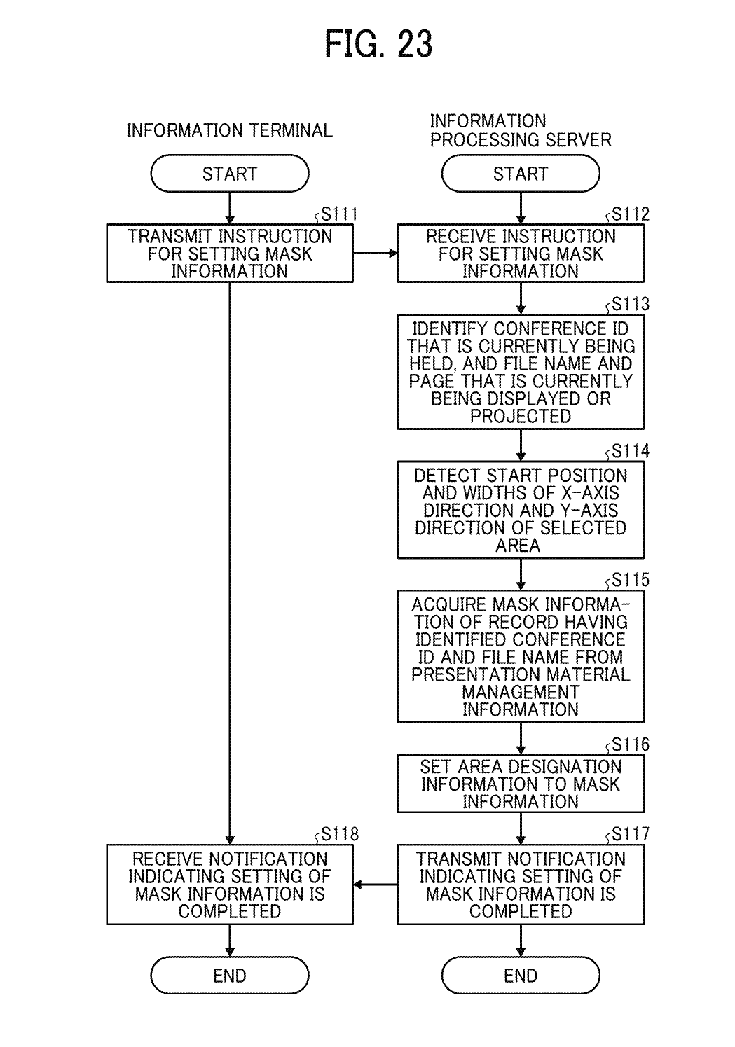

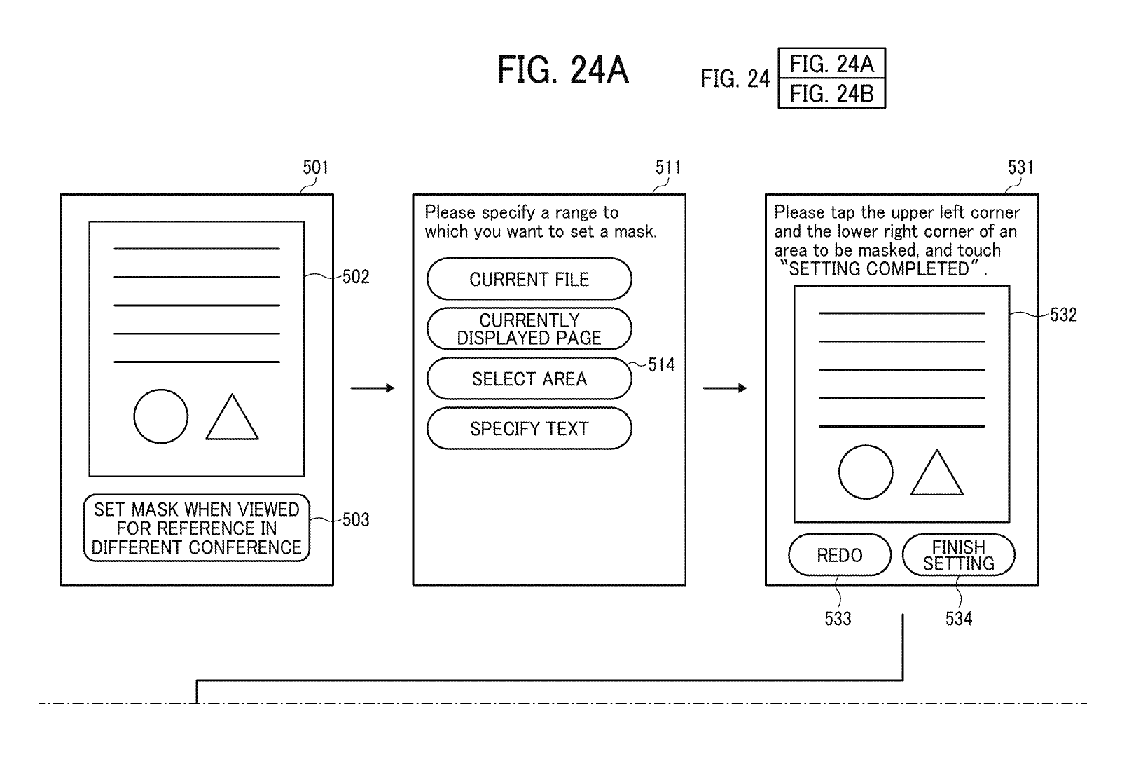

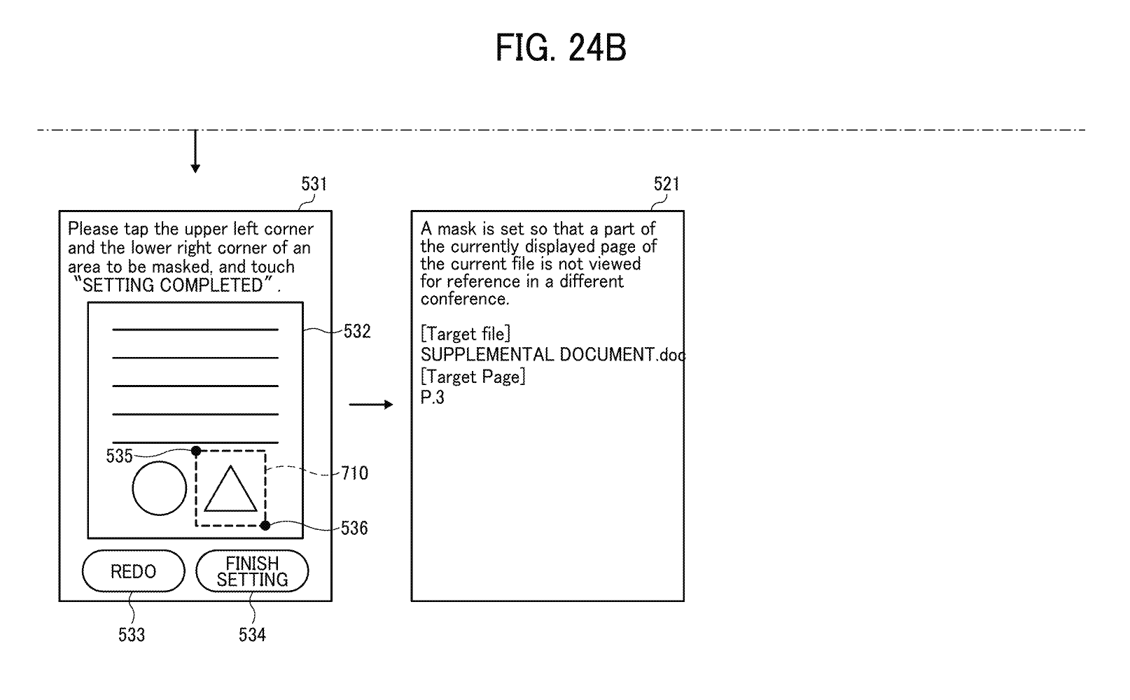

Hereinafter, a description is given of an operation performed by the information processing system 1 according to the third embodiment. FIG. 23 is a flowchart illustrating steps in an operation of setting the masking information according to the third embodiment. FIGS. 24A and 24B illustrate an example of a setting screen for setting masking information on the information terminal 30 according to the third embodiment.

As illustrated in FIG. 24A, also in the third embodiment, the file display screen 501 is displayed on the display device 306 of the information terminal 30. The same file as a file that is projected on the projector 40 or displayed on the electronic whiteboard 50 is displayed in the file display area 502 of the file display screen 501. In response to selection of the SET MASK WHEN VIEWED FOR REFERENCE IN DIFFERENT CONFERENCE key 503 by the conference participant on the file display screen 501 as illustrated in FIG. 24A, the mask setting unit 341 of the information terminal 30 displays the masking range designation screen 511 as illustrated in FIG. 24A on the display device 306.

Further, in response to selection of a SELECT AREA key 514 by the conference participant on the masking range designation screen 511, the mask setting unit 341 displays a masking area setting screen 531 as illustrated in FIG. 24A on the display device 306. The masking area setting screen 531 includes a page display area 532, a REDO key 533, and a FINISH SETTING key 534. The page display area 532 enables the conference participant to select an area to be masked. The REDO key 533 accepts an instruction for redoing selection of the area selected in the page display area 532. The FINISH SETTING key 534 accepts an instruction for setting the area selected in the page display area 532 as an area to be masked.

As illustrated in FIG. 24B, the conference participant sets the area 710 to be masked in the page display area 532. In this example, the conference participant taps two points 535 and 536 to select the area 710 having a rectangular shape whose diagonal corners are the points 535 and 536. In response to selection of the FINISH SETTING key 534, the mask setting unit 341 sends, to the information processing server 10 via the wireless communication controller 33, an instruction for setting the masking information for the selected area 710 on a page being displayed on the masking area setting screen 531 (S111).

In response to receiving the instruction for setting the masking information (S112), the masking information adder 142 of the information processing server 10 identifies the conference ID of a conference that a user who possesses the information terminal 30 is attending (S113). Further, the masking information adder 142 identifies a file name of a file and a page that is being displayed on the information terminal 30 or the electronic whiteboard 50 or projected on the projector 40 (S113). Next, the masking information adder 142 detects the x- and y-coordinates of the starting position of the area 710 selected on the masking area setting screen 531 and the widths of the area 710 in a x- and y-directions (S114). Specifically, the information processing server 10 detects a position that is selected by tap operation or with a mouse in the page display area 532 in the masking area setting screen 531 on the information terminal 30. Otherwise, the mask setting unit 341 of the information terminal 30 may detect the position selected in the page display area 532, and transmit the detection result to the information processing server 10.

Subsequently, the masking information adder 142 acquires masking information of a record having the identified conference ID and file name from the presentation material management information 132 (S115). The masking information adder 142 sets, to the acquired masking information, the area designation information including the page identified at S113 and the starting position and widths of the area 710 acquired at S114 (S116).

Thereafter, the communication unit 11 transmits, to the information terminal 30, a notification indicating that the setting of the masking information has been completed (S117). The information terminal 30 receives the notification indicating that the setting of the masking information has been completed (S118). The mask setting completion notification screen 521 as illustrated in FIG. 24B is displayed on the display device 306 of the information terminal 30. On the mask setting completion notification screen 521, a message is displayed indicating that a mask has been set to a part of the target page of the target file name. Then, the operation ends.

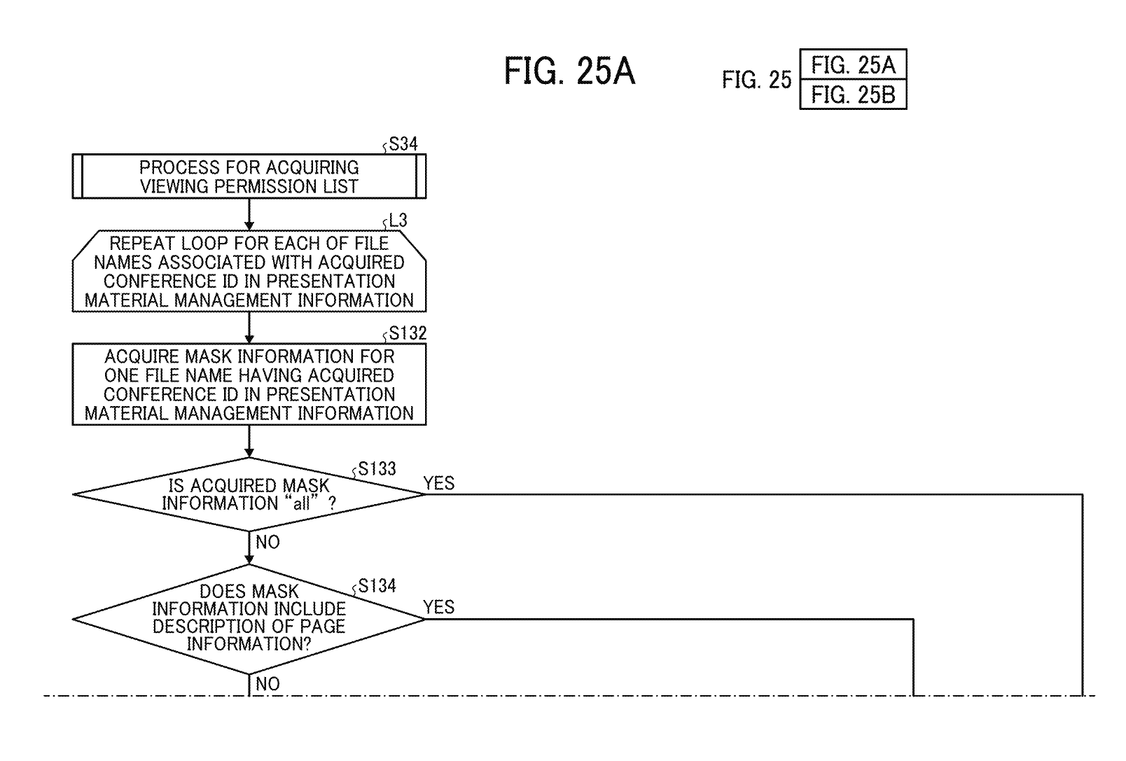

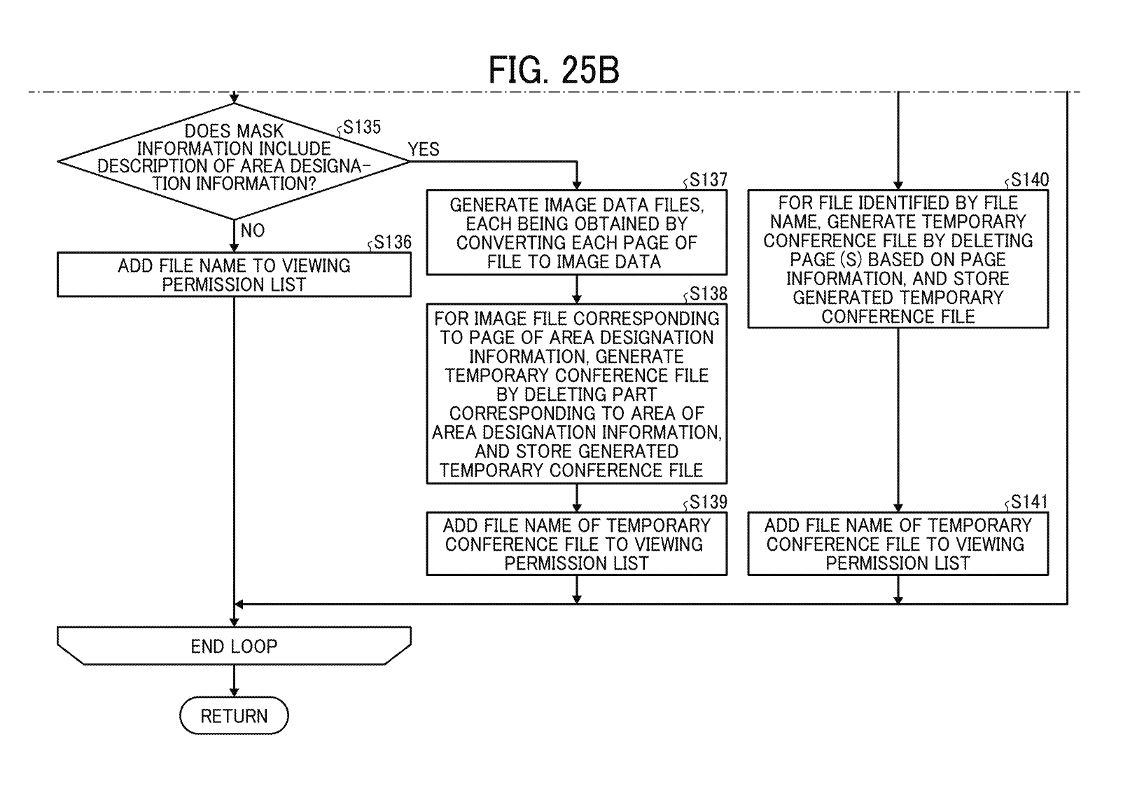

The presentation material 131 is displayed in the second conference in substantially the same manner as described above with reference to FIG. 12, except for the process of acquiring the viewing permission list. Accordingly, a description is given hereinafter of the process of acquiring the viewing permission list according to the third embodiment. FIGS. 25A and 25B are a flowchart illustrating steps in an operation of acquiring the viewing permission list according to the third embodiment.

Upon acquiring the conference ID (S33 of FIG. 12), the information processing server 10 performs a loop L3 from S132 to S141 for each of file names associated with the acquired conference ID in the presentation material management information 132. A description is given hereinafter assuming that the presentation material 131 is viewed in the second conference and the instruction acquired at S32 of FIG. 12 includes information that instructs reading out the masked presentation material 131, for example.

First, for a given one of the file names that are associated with the acquired conference ID in the presentation material management information 132, the masking information determiner 144 acquires the masking information (S132). Subsequently, the masking information determiner 144 determines whether the acquired masking information is ‘all’ (S133). In a case in which the acquired masking information is not ‘all’ (S133: NO), the masking information determiner 144 determines whether there is a description of the page information in the acquired masking information (S134).

In a case in which there is no description of the page information in the masking information (S134: NO), the masking information determiner 144 determines whether masking information includes description of the area designation information (S135). In a case in which there is no description of the area designation information in the masking information (S135: NO), the decider 145 adds the file name as the current determination target to alternatives in the viewing permission list (S136).

By contrast, in a case in which there is a description of the area designation information in the masking information (S135: YES), the temporary file generator 148 generates an image file obtained by converting each page of the target file into an image (S137). Subsequently, the temporary file generator 148 removes a part corresponding to an area to be masked specified by the area designation information from an image file corresponding to a page specified by the area designation information. With this operation, the temporary presentation file 133 constituted by an image file in which a part specified by the area designation information is masked is generated. Next, the temporary file storage unit 149 stores the generated temporary presentation file 133 in the presentation material related data storage unit 13 (S138). Thereafter, the decider 145 adds a name of the generated temporary presentation file 133 to the viewing permission list (S139).

In a case in which there is a description of the page information in the masking information (S134: YES), the information processing server 10 performs the same or substantially the same processes of those of S96 to S97 of FIG. 19. Specifically, the temporary file generator 148 generates the temporary presentation file 133 that is obtained by deleting a page or pages described in the page information from the file specified by the file name (S140). The temporary file storage unit 149 stores the generated temporary presentation file 133 in the presentation material related data storage unit 13 (S140). Further, the decider 145 adds a name of the generated temporary presentation file 133 to the viewing permission list (S141).

After S136, S139 or S141, or in a case in which the acquired masking information is ‘all’ (S133: YES), the processing for the current determination target file ends. The processing from S132 to S141 is performed for each of the file names associated with the acquired conference ID.

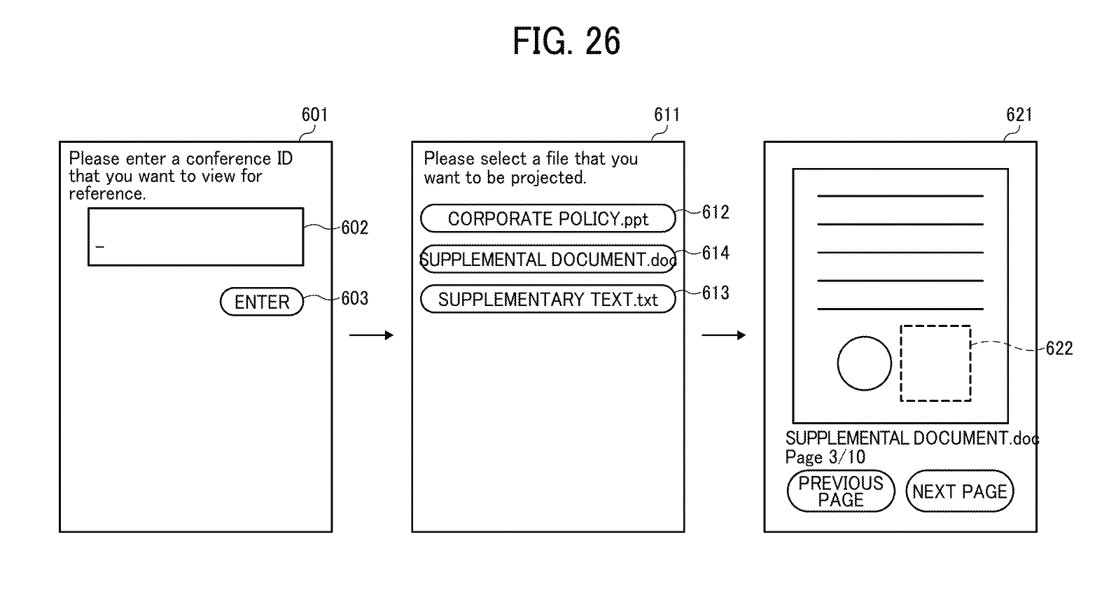

Hereinafter, a description is given of a display process by the information terminal 30 in a transmission process of the presentation materials, assuming that the viewing permission list is generated based on the presentation material management information 132 illustrated in FIG. 22. FIG. 26 illustrates an example of a display screen displayed on the information terminal 30 in a transmission process of presentation materials according to the third embodiment.

As illustrated in FIG. 26, when the information terminal 30 accepts an entry of the conference ID in the conference ID entry field 602 on the conference ID input screen 601, and thereafter accepts selection of the ENTER key 603, the viewing permission list display screen 611 is displayed on the display device 306 of the information terminal 30. The viewing permission list display screen 611 includes the ‘Corporate Policy.ppt’ key 612, the ‘Supplemental Document.doc’ key 614, and the ‘Supplemental Text.txt’ key 613. In this example, a file associated with the ‘Supplemental Document.doc’ key 614 is the temporary presentation file 133 in which a part of page 3 and a part of page 4 are masked. Accordingly, in response to selection of the ‘Supplemental Document.doc’ key 614, ‘Supplemental Document.doc’ in the temporary presentation file 133 is read out, rather than ‘Supplemental Document.doc’ in the presentation material 131. Compared with a content displayed in the page display area 532 on the masking area setting screen 531 illustrated in FIGS. 24A and 24B, an area 622 is blank on the file display screen 621 illustrated in FIG. 26.

As described heretofore, according to the third embodiment, a certain part that should not be viewed in the second conference is selected in a certain file of the presentation material 131. Further, the selection result is recorded in the presentation material management information 132 that associates the conference ID with file names. In the second conference, from among the files associated with the selected conference ID, with respect to a file in which a part of page is set to be masked, the temporary presentation file 133 is generated by performing a masking process on an image file obtained by converting each page of the file into an image. Further, the temporary presentation file 133 is added to the viewing permission list. Even in a case in which one page of a file used in the first conference contains a part that the second conference participant should be allowed to view and a part that the second conference participant should be restricted from viewing, the third embodiment enables disclosure of only the part that the second conference participant is allowed to view. The third embodiment is especially efficient for masking a figure, a graph, a table, or a mass of paragraphs.

### Fourth Embodiment

A description is given above of the third embodiment, in which a desired area in a page is selected for masking. However, it takes time for configuring settings, when one wants to mask a term or a phrase that appears repeatedly throughout a page. To address this issue, a description is given hereinafter of a fourth embodiment, in which a specific text pattern in a file is masked.

The information processing server 10 according to the fourth embodiment has substantially the same configuration as that of the second and third embodiments, except that the fourth embodiment specifies text hiding information and/or text replacing information in the masking information. More specifically, according to the fourth embodiment, the text hiding information that indicates text to be masked in a file and/or the text replacing information that indicates text to be replaced in a file can be specified in the masking information of the presentation material management information 132 stored in the presentation material related data storage unit 13, in addition to the file-by-file basis and the page-by-page basis masking specification and the specification of an area to be masked in a page.

For example, an expression of ‘hide=“AAA”’ can be used as the text hiding information, where AAA denotes an arbitrary text. This text hiding information specifies that the text ‘AAA’ existing in a file is to be masked. Further, ‘hide=“.*AAA.*”’ as the text hiding information specifies that the preceding and succeeding portions including the text ‘AAA’, e.g., a line containing the text ‘AAA’, is a masking target.

Further, for example, an expression of ‘replace=“AAA”, “BBB”’ can be used as the text replacing information, where AAA denotes text before replacement and BBB denotes text after replacement. This text hiding information specifies that text ‘AAA’ existing in a file is to be replaced with text ‘BBB’. Furthermore, various modifications can be defined for this replacement of the text. For example, text in the text before replacement is parenthesized, and it can be defined that the text is expressed by ‘¥1’. According to such definition, when the text replacing information is expressed by ‘replace=“(ordinary income:)[0-9 thousand million billion]+yen”, “¥1***”’, the text ‘ordinary income: CCC yen’ that exists in a file is replaced with text ‘ordinary income: ***’, where CCC denotes an arbitrary numeral.

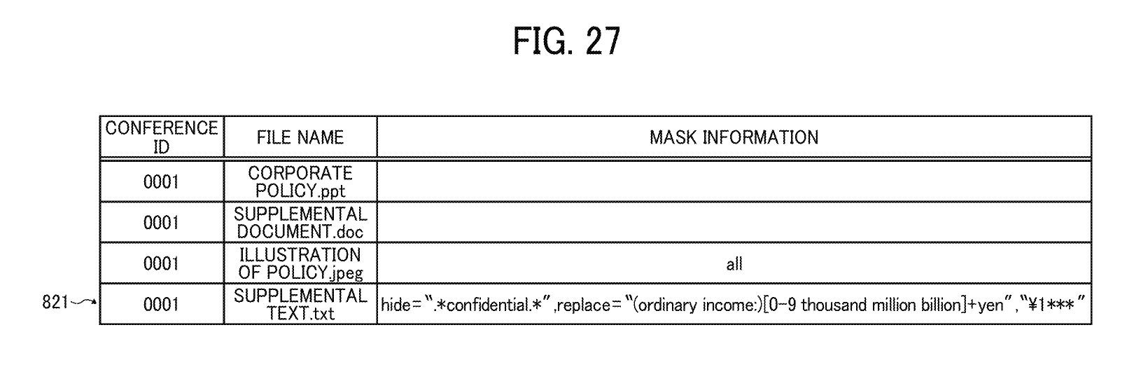

FIG. 27 illustrates an example of the presentation material management information 132 according to the fourth embodiment. FIG. 27 illustrates an example in which the text hiding information and the text replacing information as defined in the above are set in the masking information of a record 821.

In a case in which the masking information includes the text hiding information and/or the text replacing information, the temporary file generator 148 copies the corresponding file in the presentation material 131. Further, the temporary file generator 148 masks the corresponding text and/or replaces the corresponding text from the copied file to generate the temporary presentation file 133. The temporary file storage unit 149 stores this temporary presentation file 133 in the presentation material related data storage unit 13.

The configuration according to the fourth embodiment is the same or substantially the same as that of the first to third embodiments, expect for the text hiding information and the text replacing information as described above. Therefore, redundant description is omitted below. Further, the configuration of the information terminal 30 according to the fourth embodiment is the same or substantially the same as that of the first embodiment. Therefore, redundant description thereof is omitted below. Furthermore, the hardware configurations of the information processing server 10 and the information terminal 30 according to the fourth embodiment are the same or substantially the same as those of the first embodiment. Therefore, redundant description thereof is omitted below.

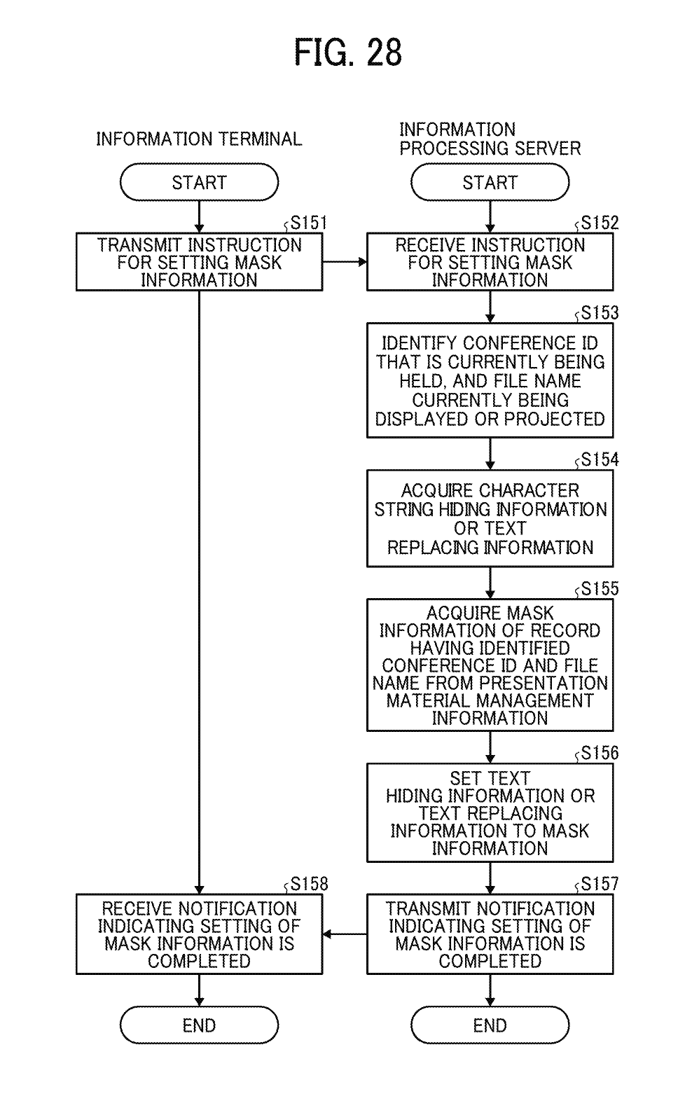

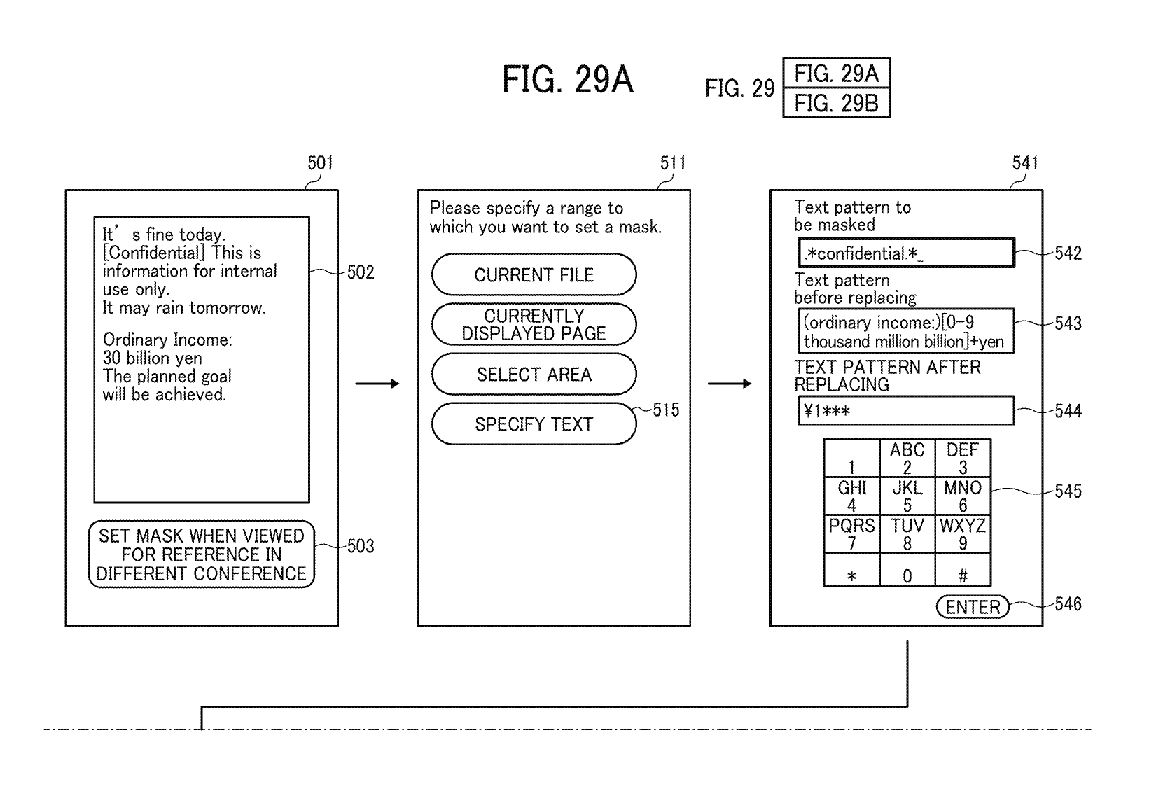

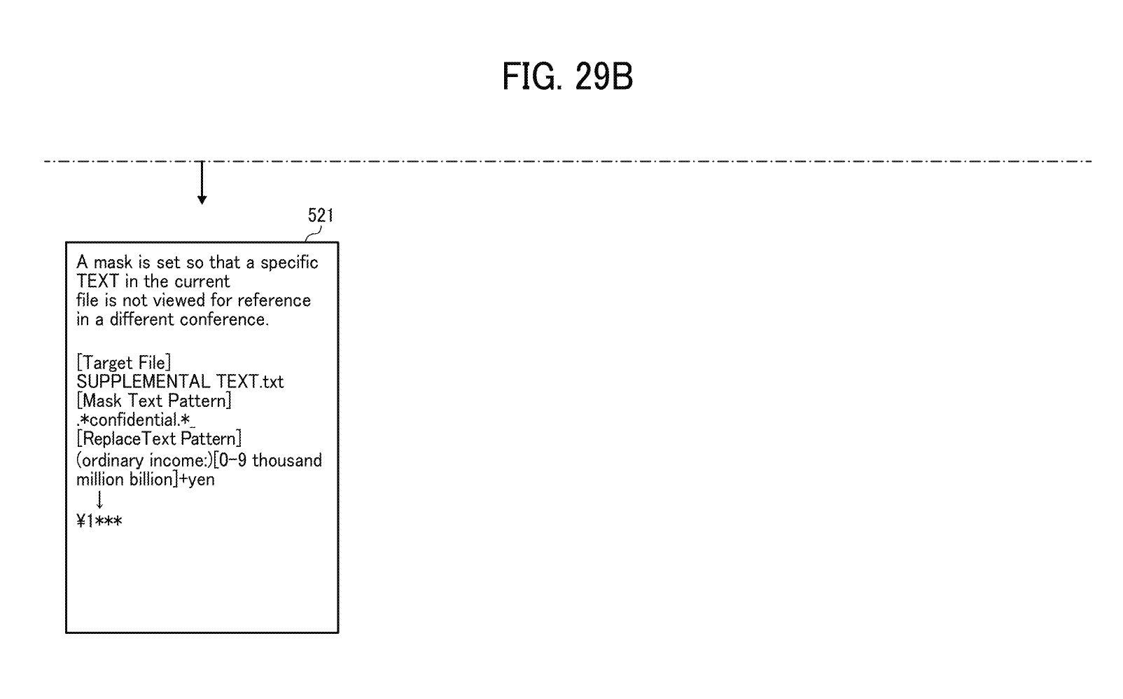

Hereinafter, a description is given of an operation performed by the information processing system 1 according to the fourth embodiment. FIG. 28 is a flowchart illustrating steps in an operation of setting the masking information according to the fourth embodiment. FIGS. 29A and 29B illustrate an example of a setting screen for setting masking information on the information terminal 30 according to the fourth embodiment.

As illustrated in FIG. 29A, also in the fourth embodiment, the file display screen 501 is displayed on the display device 306 of the information terminal 30. A file containing same text data as that of a file projected on the projector 40 or displayed on the electronic whiteboard 50 is displayed in the file display area 502 of the file display screen 501. In response to selection of the SET MASK WHEN VIEWED FOR REFERENCE IN DIFFERENT CONFERENCE key 503 by the conference participant on the file display screen 501, the mask setting unit 341 of the information terminal 30 displays the masking range designation screen 511 as illustrated in FIG. 29A on the display device 306.

Further, in response to selection of a SELECT TEXT key 515 by the conference participant on the masking range designation screen 511, the mask setting unit 341 displays a text setting screen 541 as illustrated in FIG. 29A on the display device 306. The text setting screen 541 includes a masked text entry field 542, a before-replacement text entry field 543, an after-replacement text entry field 544, a software keyboard 545, and an ENTER key 546. The masked text entry field 542 accepts specification of a text pattern to be masked. The before-replacement text entry field 543 accepts specification of a text pattern before replacement in a case in which text replacement is to be performed. The after-replacement text entry field 544 accepts specification of a text pattern after replacement in a case in which text replacement is to be performed. The software keyboard 545 is used for entering a text pattern in the masked text entry field 542, the before-replacement text entry field 543, and the after-replacement text entry field 544. The ENTER key 546 accepts an instruction for setting the text pattern entered in the masked text entry field 542 as text to be masked. Further, the ENTER key 546 accepts an instruction for setting the text pattern entered in the before-replacement text entry field 543 and the after-replacement text entry field 544 as text to be replaced.

In this embodiment, it is assumed that, as illustrated in FIG. 29A, ‘*confidential.*’ is set to the masked text entry field 542, ‘(ordinary income[0-9]thousand million billion]+yen’ is entered in the before-replacement text entry field 543, ‘¥1***’ is entered in the after-replacement text entry field 544, and thereafter the ENTER key 546 is selected. The mask setting unit 341 transmits, to the information processing server 10 via the wireless communication controller 33, an instruction for setting the masking information for the selected text pattern in a file currently being displayed on the file display screen 501 (S151).

In response to receiving the instruction for setting the masking information (S152), the masking information adder 142 of the information processing server 10 identifies the conference ID of a conference that a user who possesses the information terminal 30 is attending (S153). Further, the masking information adder 142 identifies file name of a file that is being displayed on the information terminal 30 or the electronic whiteboard 50 or projected on the projector 40 (S153).

Subsequently, the masking information adder 142 acquires text hiding information or text replacing information for the file that is currently displayed or projected (S154). Specifically, the masking information adder 142 extracts contents entered on the text setting screen 541 of FIG. 29A from the instruction received at S152 to acquire the text hiding information or the text replacement information. The text hiding information is text to be masked, and the text replacing information is text before replacement and text after replacement.

Subsequently, the masking information adder 142 acquires masking information of a record having the identified conference ID and file name from the presentation material management information 132 (S155). Next, the masking information adder 142 sets the text hiding information or the text replacing information acquired at S154 to the masking information (S156).

Upon completion of the masking information setting, the communication unit 11 transmits, to the information terminal 30, a notification indicating that the setting of the masking information has been completed (S157). The information terminal 30 receives the notification indicating that the setting of the masking information has been completed (S158). The mask setting completion notification screen 521 as illustrated in FIG. 29B is displayed on the display device 306 of the information terminal 30. On the mask setting completion notification screen 521, a message is displayed indicating that the text hiding information and the text replacing information have been set to the target file name. Then, the operation ends.

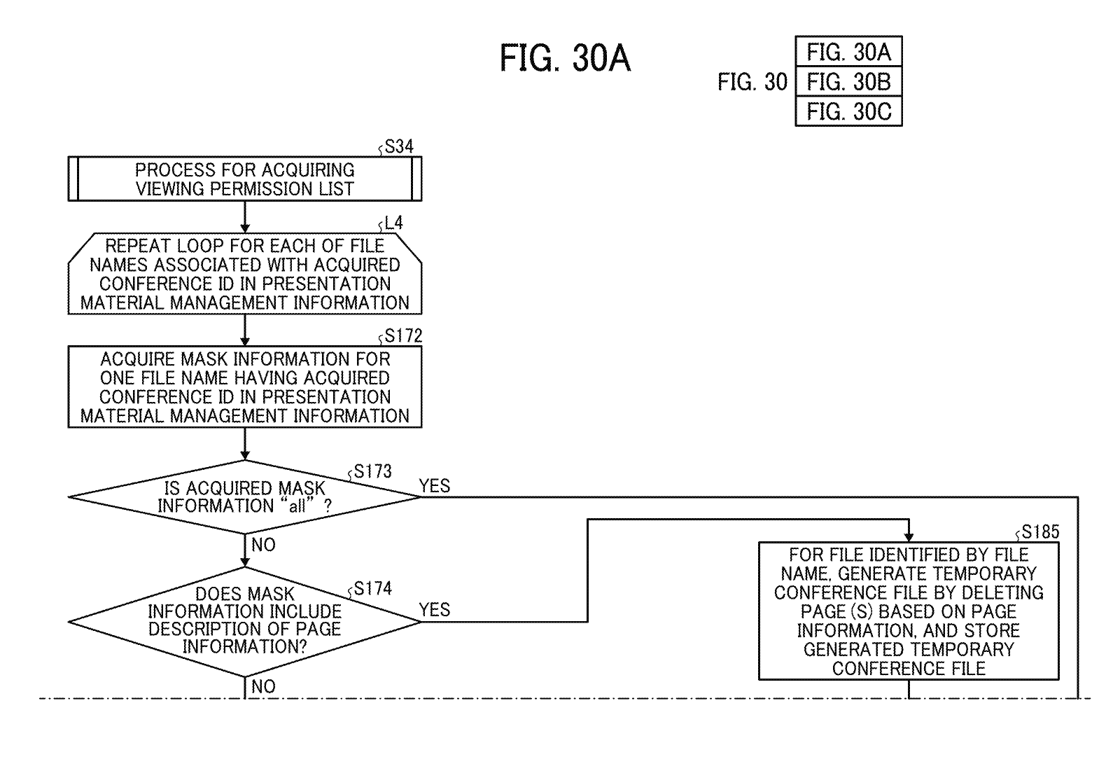

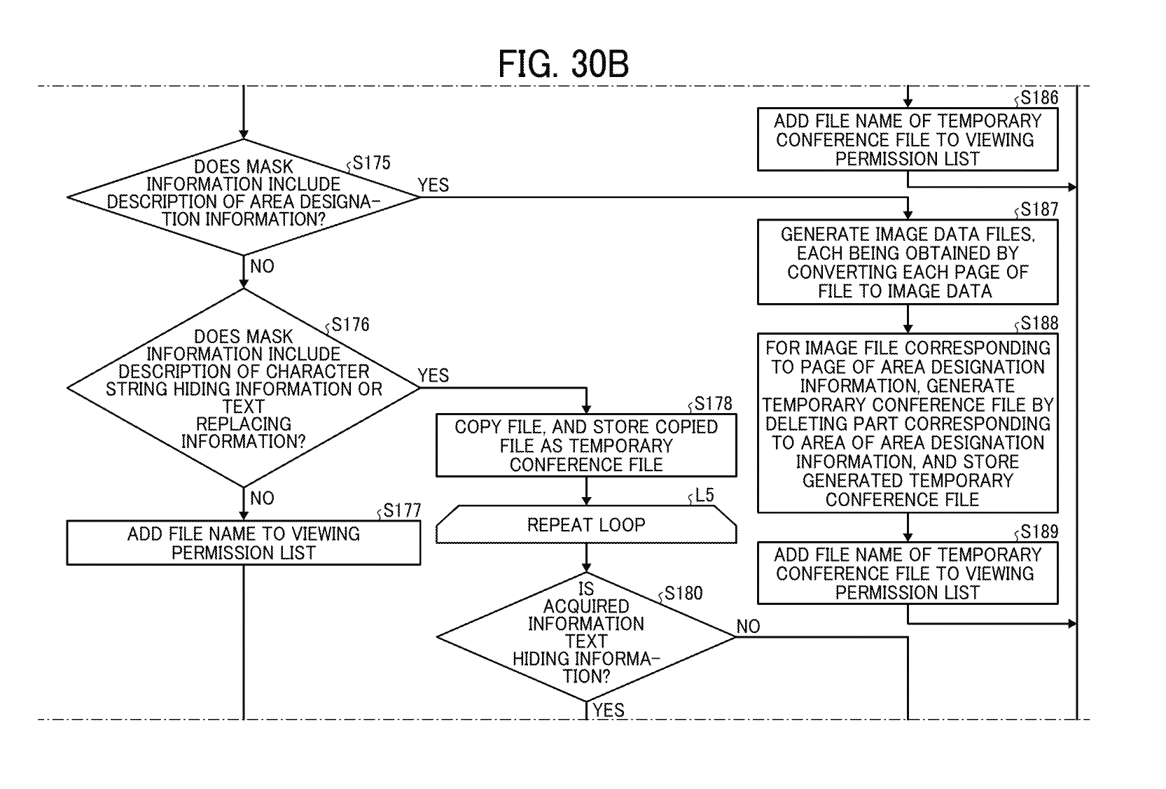

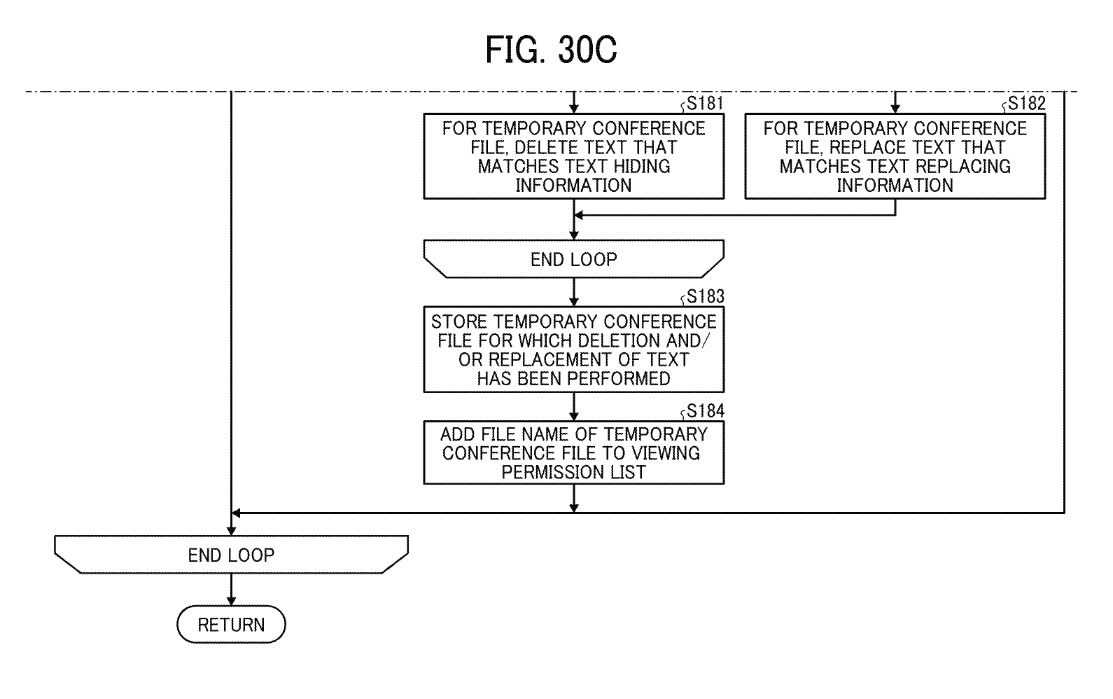

The presentation material 131 is displayed in the second conference in substantially the same manner as described above with reference to FIG. 12, except for the process of acquiring the viewing permission list. Accordingly, a description is given hereinafter of the process of acquiring the viewing permission list according to the fourth embodiment. FIGS. 30A to 30C are a flowchart illustrating steps in an operation of acquiring the viewing permission list according to the fourth embodiment.

Upon acquiring the conference ID (S33 of FIG. 12), the information processing server 10 performs a loop L4 from S172 to S189 for each of files associated with the acquired conference ID in the presentation material management information 132. A description is given hereinafter assuming that the presentation material 131 is viewed in the second conference and the instruction acquired at S32 of FIG. 12 includes information that instructs reading out the masked presentation material 131, for example.

The masking information determiner 144 performs the same or substantially the same processes as those of S132 to S135 of FIGS. 25A and 25B. Specifically, for a given one of the file names associated with the acquired conference ID in the presentation material management information 132, the masking information determiner 144 acquires the masking information (S172). Further, the masking information determiner 144 determines whether the acquired information is ‘all’, whether there is a description of the page information in the masking information, and whether there is a description of the area designation information in the masking information (S173-S175).

In a case in which there is no description of the area designation information in the masking information (S175: NO), the masking information determiner 144 determines whether there is a description of the text hiding information or the text replacing information in the masking information (S176). In a case in which there is no description of the text hiding information or the text replacing information in the masking information (S176: NO), the decider 145 adds the file name as the current determination target to alternatives in the viewing permission list (S177).

By contrast, in a case in which there is a description of the text hiding information or the text replacing information (S176: YES) in the masking information, the temporary file generator 148 copies a file of the file identified by the file name (S178). Further, the temporary file storage unit 149 stores the copied file as the temporary presentation file 133 in the presentation material related data storage unit 13 (S178).

Subsequently, the temporary file generator 148 performs a loop L5 of S180 to S182 for each piece of the text hiding information and the text replacing information included in the masking information.

First, the temporary file generator 148 determines whether the acquired information is the text hiding information (S180). In a case in which the acquired information is the text hiding information (S180: YES), the temporary file generator 148 removes text that matches the acquired text hiding information from the temporary presentation file 133 (S181). By contrast, in a case in which the acquired information is not the text hiding information (S180: NO), i.e., in a case which the acquired information is the text replacing information, the temporary file generator 148 replaces text that matches the before-replacement text specified by the text replacing information in the temporary presentation file 133 with the after-replacement text (S182).

After performing L5 for each and every piece of the text hiding information and the text replacing information included in the masking information, the temporary file storage unit 149 stores the temporary presentation file 133 for which text removal and/or replacement has been performed (S183). Further, the decider 145 adds a name of the temporary presentation file 133 to the viewing permission list (S184).

In a case in which there is a description of the page information in the masking information (S174: YES), the information processing server 10 performs the same or substantially the same processes of those of S96 to S97 of FIG. 19. Specifically, the temporary file generator 148 generates the temporary presentation file 133 that is obtained by deleting a page or pages described in the page information from the target file (S185). The temporary file storage unit 149 stores the generated temporary presentation file 133 in the presentation material related data storage unit 13 (S185). Further, the decider 145 adds a name of the generated temporary presentation file 133 to the viewing permission list (S186).

In a case in which there is a description of the area designation information in the masking information (S175: YES), the information processing server 10 performs the same or substantially the same processes of those of S137 to S139 of FIG. 25B. Specifically, the temporary file generator 148 generates an image file obtained by converting each page of the file into an image (S187). Further, the temporary file generator 148 removes a part corresponding to an area to be masked specified by the area designation information from an image file corresponding to a page specified by the area designation information to generate the temporary presentation file 133. The temporary file storage unit 149 stores the generated temporary presentation file 133 in the presentation material related data storage unit 13 (S188). Thereafter, the decider 145 adds a name of the generated temporary presentation file 133 to the viewing permission list (S189).

After S177, S184, S186 or S189, or in a case in which the acquired masking information is ‘all’ (S173: YES), the processing for the current determination target file ends. The processing from S172 to S189 is performed for each of the file names associated with the acquired conference ID.

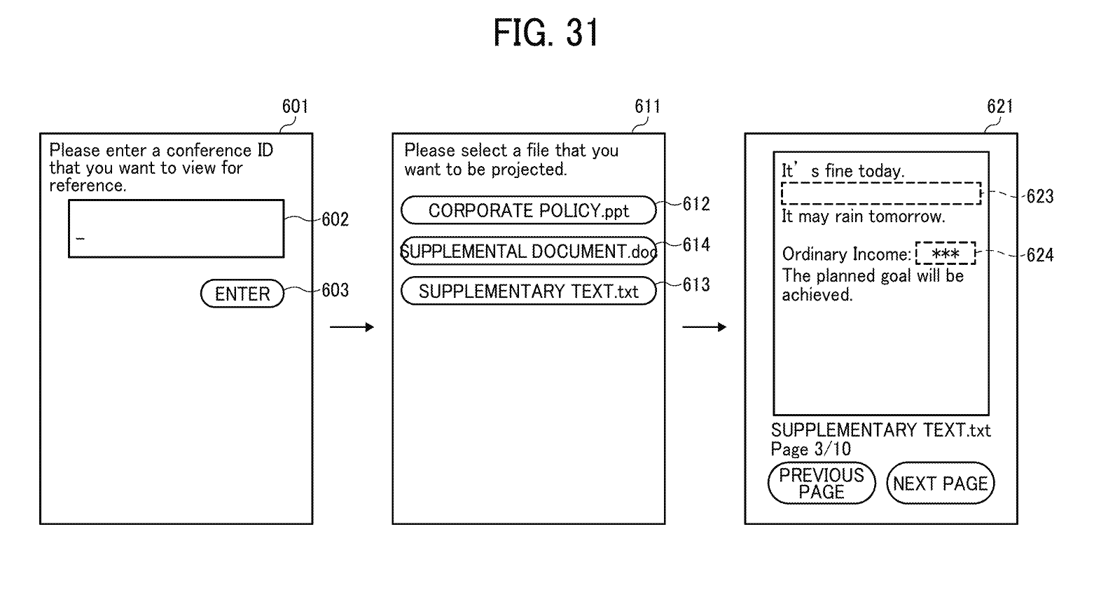

Hereinafter, a description is given of a display process by the information terminal 30 in a transmission process of the presentation materials, assuming that the viewing permission list is generated based on the presentation material management information 132 illustrated in FIG. 27. FIG. 31 illustrates an example of a display screen displayed on the information terminal 30 in a transmission process of presentation materials according to the fourth embodiment.

As illustrated in FIG. 31, when the information terminal 30 accepts an entry of the conference ID in the conference ID entry field 602 on the conference ID input screen 601, and thereafter accepts selection of the ENTER key 603, the viewing permission list display screen 611 is displayed on the display device 306 of the information terminal 30. The viewing permission list display screen 611 includes the ‘Corporate Policy.ppt’ key 612, the ‘Supplemental Document.doc’ key 614, and the ‘Supplemental Text.txt’ key 613. In this example, a file associated with the ‘Supplemental Text.txt’ key 613 is the temporary presentation file 133 in which a part of text is removed and replaced. Accordingly, in response to selection of the ‘Supplemental Text.txt’ key 613, ‘Supplemental Text.txt’ in the temporary presentation file 133 is read out, rather than ‘Supplemental Text.txt’ in the presentation material 131, as illustrated in FIG. 31. Compared with a displayed content in the file display area 502 on file display screen 501 illustrated in FIG. 29A, text in an area 623 has been removed and text in an area 624 has been replaced on the file display screen 621 illustrated in FIG. 31.

As described heretofore, according to the fourth embodiment, text in the presentation material 131 that should not be viewed in the second conference is selected. Further, the selection result is recorded in the presentation material management information 132 that associates the conference ID with file names. In the second conference, from among the files associated with the selected conference ID, with respect to text for which a mask is set, the temporary presentation file 133 is generated by masking the text based on the masking information. Further, the temporary presentation file 133 is added to the viewing permission list. Even in a case in which a file used in the first conference contains a part that the second conference participant should be allowed to view and a part that the second conference participant should be restricted from viewing, the fourth embodiment enables disclosure of only the part that the second conference participant is allowed to view.

In addition, because the fourth embodiment replaces text that the second conference participant should be restricted from viewing, the forth embodiment enables preventing the second conference participant from getting to know important information discussed in the first conference.

### Fifth Embodiment

A description is given above of the fourth embodiment, in which text hiding or replacement in a file is set by the masking information. Hereinafter, a description is given of a fifth embodiment, in which establishment conditions of determined content are set in the masking information.

The information processing server 10 according to the fifth embodiment has substantially the same configuration as that of the second to fourth embodiments, except that the fifth embodiment specifies a mask execution condition in the masking information. More specifically, according to the fifth embodiment, in addition to the file-by-file basis and the page-by-page basis masking specification, the specification of an area to be masked in a page, and the specification of the text hiding information or the text replacing information, the mask execution condition that is to be satisfied for establishing such masking or text replacement can be specified in the masking information of the presentation material management information 132 stored in the presentation material related data storage unit 13. The mask execution condition defines whether to enable the specification of masking and the text replacement depending on a type of conference or the title of participant. For example, the mask execution condition includes ‘top secret’ and ‘confidential’. The ‘top secret’ or ‘confidential’ is set to the specification of masking or the specification of the text replacing information that are set in the masking information.

For example, an expression of ‘&condition=“CCC”’ can be used as the mask execution condition, where CCC denotes text. The mask execution condition is stored as being added to the masking information according to the first to fourth embodiments. For example, ‘hide=“.*confidential.*”&condition=“confidential”’ indicates that a line containing ‘confidential’ is to be masked when ‘confidential’ is selected in the mask execution condition. Further, ‘replace=“(ordinary income:) [0-9 thousand million billion]+yen”, “¥1***” &condition=“top secret”’ indicates that an amount of an ordinary income is to be replaced with ‘***’ when ‘top secret’ is selected in the mask execution condition.

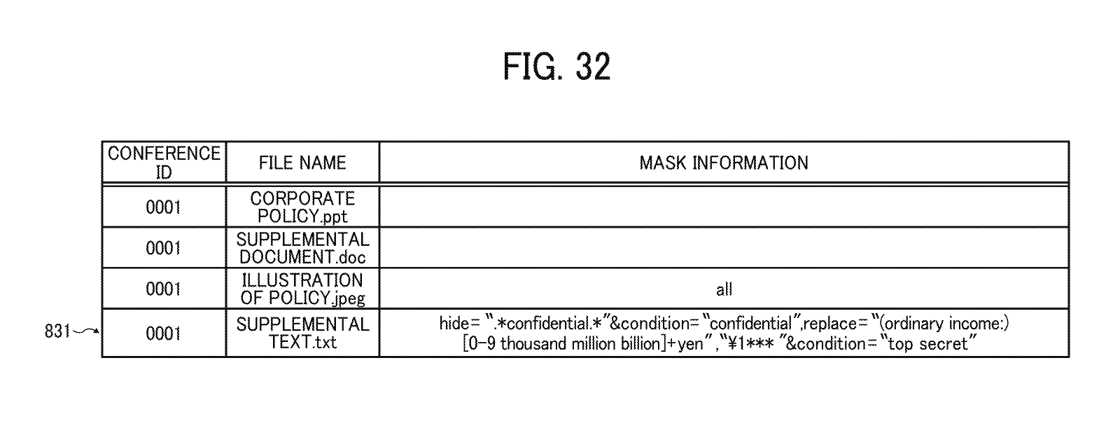

FIG. 32 illustrates an example of the presentation material management information 132 according to the fifth embodiment. FIG. 32 illustrates an example in which the text hiding information and the text replacing information to which the mask execution condition is added as defined in the above are set in the masking information of a record 831. Further, the decider 145 determines whether the mask execution condition in the presentation material management information 132 matches a readout condition that is set on the information terminal 30 when reading out a file in the second conference. Furthermore, based on the determination result, the decider 145 validates or invalidates the mask or replacement that has been set.

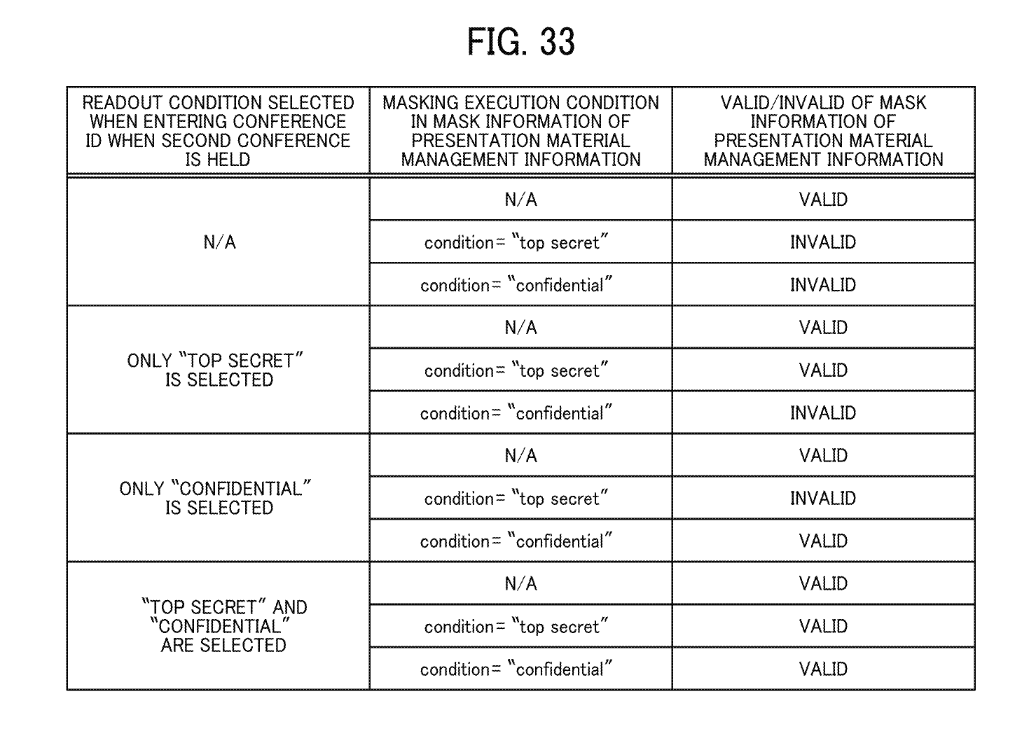

FIG. 33 illustrates an example of validation or invalidation of the masking information, depending on combinations of the readout condition that is set in the second conference and the mask execution condition in the presentation material management information 132. As illustrated in FIG. 33, the masking information to which no mask execution condition set is always valid. Further, in a case in which the readout condition matches the mask execution condition in the presentation material management information 132, the masking information having the same mask execution condition as the readout condition is valid. By contrast, the masking information having the mask execution condition that is not specified in the readout condition is invalid.

The configuration according to the fifth embodiment is the same or substantially the same as that of the first to fourth embodiments, expect for the mask execution condition as described above. Therefore, redundant description is omitted below. Further, the configuration of the information terminal 30 according to the fifth embodiment is the same or substantially the same as that of the first embodiment. Therefore, redundant description thereof is omitted below. Furthermore, the hardware configurations of the information processing server 10 and the information terminal 30 according to the fifth embodiment are the same or substantially the same as those of the first embodiment. Therefore, redundant description thereof is omitted below.

Hereinafter, a description is given of an operation performed by the information processing system 1 according to the fifth embodiment. However, the setting process of the masking information is performed in the same or substantially the same manner as described above with reference to the flowchart of FIG. 28 in the fourth embodiment, and therefore the redundant description thereof is omitted below. A description is given hereinafter of an example operation of setting the masking information performed by the information terminal 30.

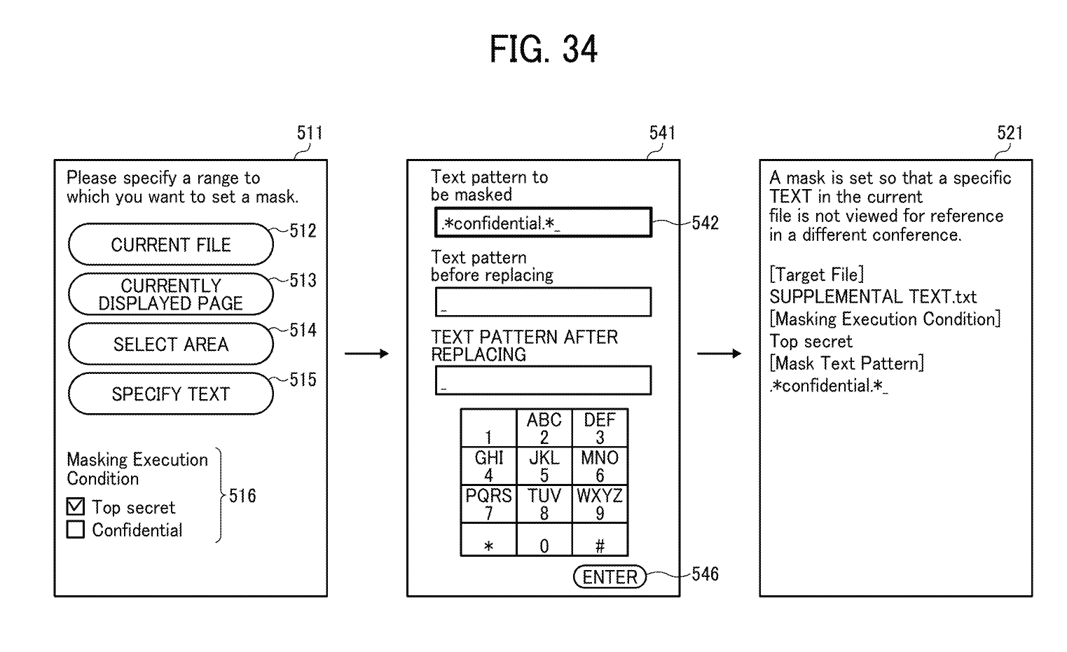

FIG. 34 illustrates an example of a setting screen for setting the masking information on the information terminal 30 according to the fifth embodiment. Also in the fifth embodiment, the file display screen 501 as illustrated in FIG. 29A is displayed on the display device 306 of the information terminal 30. A file containing same text data as that of a file projected on the projector 40 or displayed on the electronic whiteboard 50 is displayed in the file display area 502 of the file display screen 501. In response to selection of the SET MASK WHEN VIEWED FOR REFERENCE IN DIFFERENT CONFERENCE key 503 by the conference participant on the file display screen 501, the mask setting unit 341 of the information terminal 30 displays the masking range designation screen 511 as illustrated in FIG. 34 on the display device 306.

The masking range designation screen 511 includes a mask execution condition selection area 516 as well as the CURRENT FILE key 512, the CURRENTLY DISPLAYED PAGE key 513, the SELECT AREA key 514, and the SELECT TEXT key 515. The mask execution condition selection area 516 includes two check boxes for selecting ‘Top secret’ and ‘Confidential’, both being the mask execution condition′.

In response to selection of ‘Top secret’ as the mask execution condition on the masking range designation screen 511 and subsequent selection of the SELECT TEXT key 515, the mask setting unit 341 displays the text setting screen 541 on the display device 306, as illustrated in FIG. 34. As illustrated in FIG. 34, in response to entry of ‘*confidential.*’ in the masked text entry field 542 and subsequent selection of the ENTER key 546, the mask setting unit 341 transmits, to the information processing server 10, an instruction for setting the masking information for the selected text pattern in a file displayed on the file display screen 501 illustrated in FIG. 29A. Although in this example, a description is given of a case in which the mask execution condition is specified for text, the mask execution condition may be specified for a file, a page in a file, and/or a selected area.

The information processing server 10 stores the contents entered on the masking range designation screen 511 and the text setting screen 541 in the presentation material management information 132 of the presentation material related data storage unit 13. Upon completion of setting, the information processing server 10 displays the mask setting completion notification screen 521 as illustrated in FIG. 34 on the information terminal 30. On the mask setting completion notification screen 521, a message is displayed indicating that the text hiding information has been set to the target file name and the mask execution condition for causing the text hiding information to be performed has been set. Then, the operation ends.

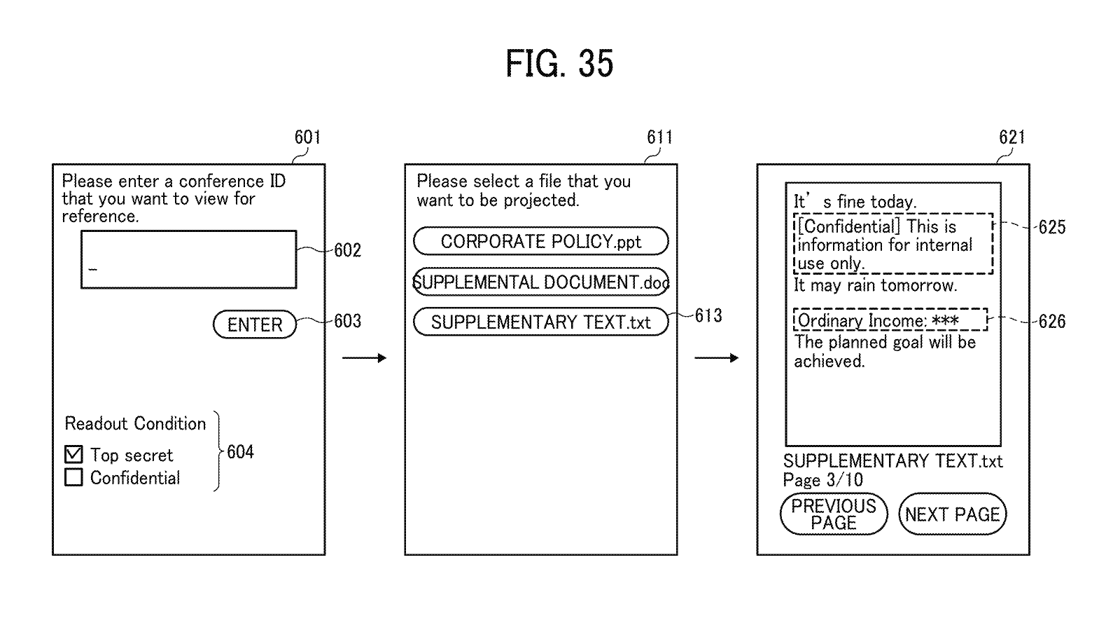

The process of displaying the presentation material 131 in the second conference is performed in the same or substantially the same manner as described above with reference to the flowchart of FIGS. 30A to 30C in the fourth embodiment, and therefore the redundant description thereof is omitted below. A description is given hereinafter of an example operation of displaying the presentation material 131 in the second conference performed by the information terminal 30. FIG. 35 schematically illustrates how presentation materials are viewed on the information terminal 30 according to the fifth embodiment. Hereinafter, a description is given of an example in which the viewing permission list is generated based on the presentation material management information 132 illustrated in FIG. 32.

First, the conference ID input screen 601 as illustrated in FIG. 35 is displayed on the display device 306 of the information terminal 30. The conference ID input screen 601 includes a readout condition setting area 604 as well as the conference ID entry field 602 and the ENTER key 603. In response to entry of the conference ID, selection of the readout condition and subsequent selection of the ENTER key 603, the information terminal 30 transmits the entered content to the information processing server 10. In this example, a description is given assuming that ‘Top secret’ is selected as the readout condition. The information processing server 10 generates the viewing permission list, and the viewing permission list display screen 611 illustrated in FIG. 35 is displayed on the information terminal 30. In response to selection of ‘Supplemental Text.txt’ key 613, the file display screen 621 illustrated in FIG. 35 is displayed.

‘Confidential’ as the mask execution condition defined in a first condition ‘hide=“.*confidential.*”&condition=“confidential”’ in the masking information of the record 831 of FIG. 32 does not match ‘top secret’ as the readout condition that is set on the conference ID input screen 601 illustrated in FIG. 35. Accordingly, the first condition is invalid based on a table of FIG. 33. Thus, as illustrated in FIG. 35, text containing [Confidential] remains displayed in an area 625 of the file display screen 621.

By contrast, ‘top secret’ as the mask execution condition defined in a second condition ‘replace=“(ordinary income:) [0-9 thousand million billion]+yen”,“¥1***”& condition=“top secret”’ in the masking information of the record 831 matches ‘top secret’ as the readout condition that is set on the conference ID input screen 601. Accordingly, the second condition is valid based on a table of FIG. 33. Thus, as illustrated in FIG. 35, an ordinary income is displayed as being replaced in an area 626 of the file display screen 621.

As described heretofore, according to the fifth embodiment, the mask execution condition in the masking information is compared with the readout condition that is set when a presentation file is displayed or projected. Based on the comparison result, in a case in which the mask execution condition is not set in the masking information, the masking information is determined as valid. Further, based on the comparison result, in a case in which the mask execution condition is set in the masking information, and the mask execution condition matches the readout condition, the masking information is determined as valid. Accordingly, the fifth embodiment enables, when selecting a portion that should not be allowed to be viewed in the second conference, to add the mask execution condition, such as ‘confidential’ and ‘top secret’, for each selected portion. This enables transmitting the presentation material 131 having a content that varies depending on a type of the second conference. For example, the fifth embodiment enables, in a simple manner, to specify ‘top secret’ as information not to be displayed in the second conference, in a case in which only corporate staffs participate in the second conference, and to specify ‘confidential’ and ‘top secrete’ as information not be displayed in the second conference, in a case in not only the corporate staffs but also outside corporate staffs participate in the second conference.

### Sixth Embodiment

In the fifth embodiment, the readout condition is set in the second conference. Hereinafter, a description is given of a sixth embodiment in which restriction is imposed on a range that can be accessed, depending on attributes of conference participants.

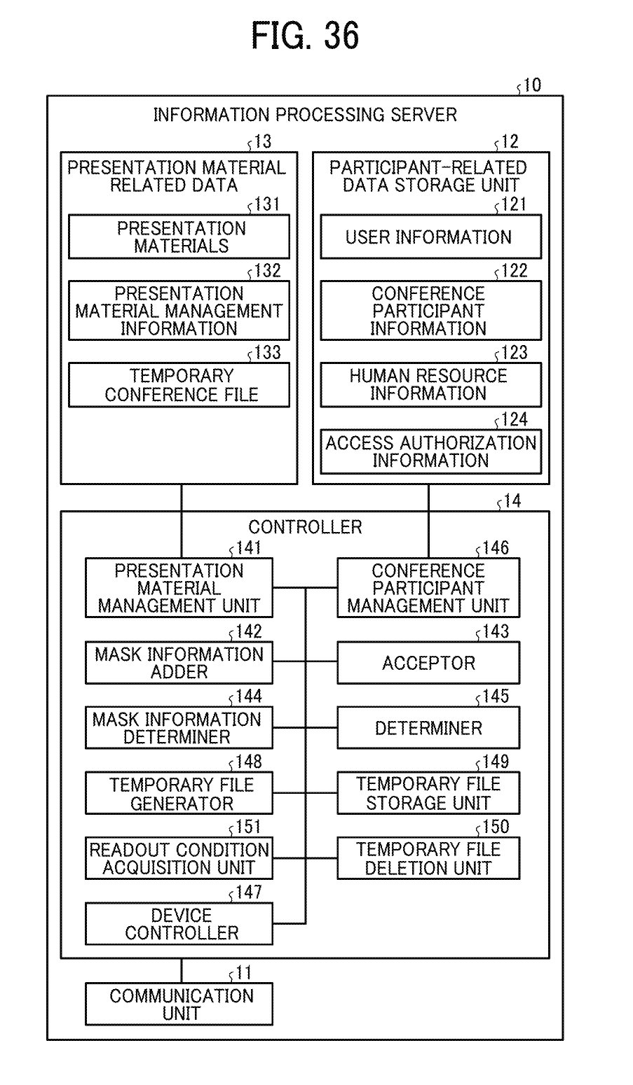

FIG. 36 is a block diagram illustrating an example functional configuration of the information processing server 10 according to the sixth embodiment. In the information processing server 10 according to the sixth embodiment, the participant related data storage unit 12 further stores human resource information 123 and access authorization information 124. The human resource information 123 is a database storing human resource information of corporate staffs and/or outside corporate staffs.

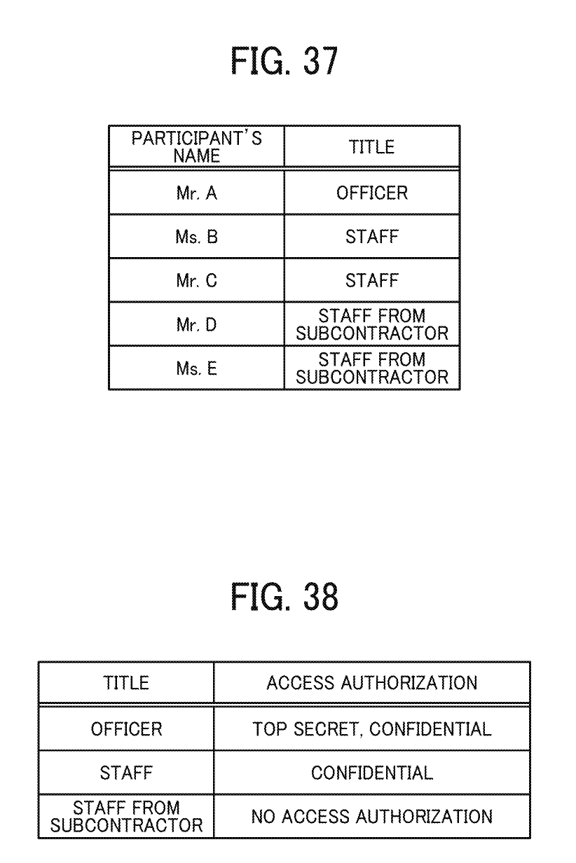

FIG. 37 illustrates an example of the human resource information 123 according to the sixth embodiment. The human resource information 123 includes a participant name and a title.

The access authorization information 124 is information defining access authorization to file content in association with each title when reading out a file. FIG. 38 illustrates an example of the access authorization information 124 according to the sixth embodiment. The access authorization information 124 includes a title and access authorization. In this example, a description is given assuming that ‘top secret’ and ‘confidential’ are set as the access authorization. For example, the access authorization information 124 illustrated in FIG. 38 indicates that a conference participant whose title is an officer can access a top secret and confidential information. Accordingly, no condition is set to the readout condition of the officer. Further, according to the access authorization information 124 illustrated in FIG. 38, a conference participant whose title is a corporate staff can access confidential information. Accordingly, ‘top secret’ is set to the readout condition of the corporate staff. Furthermore, according to the access authorization information 124 illustrated in FIG. 38, a conference participant whose title is an outside corporate staff is not allowed to access a top secret and confidential information. Accordingly, ‘top secret’ and ‘confidential’ are set to the readout condition of the outside corporate staff.

In addition, the controller 14 further includes a readout condition acquisition unit 151. In response to a request for viewing a file, the readout condition acquisition unit 151 acquires the access authorization of a user who possesses the information terminal 30 based on the ID of information terminal 30, by using the conference participant information 122, the human resource information 123, and the access authorization information 124. Further, the readout condition acquisition unit 151 sets the readout condition by using the acquired access authorization, and passes the readout condition to the decider 145. It should be noted that the readout condition is restriction that is imposed when reading out a file, while the access authorization indicates whether information in a file can be accessed. Accordingly, the presentation material management unit 141 determines conditions other than the acquired access authorization as the readout condition, when reading out a file.

In the sixth embodiment, the same reference numbers are allocated to elements (members or components) having the same function as those of the first embodiment, and redundant description thereof is omitted. Further, the configuration of the information terminal 30 according to the sixth embodiment is the same or substantially the same as that of the first embodiment. Therefore, redundant description thereof is omitted below.

Furthermore, the hardware configurations of the information processing server 10 and the information terminal 30 according to the sixth embodiment are the same or substantially the same as those of the first embodiment. Therefore, redundant description thereof is omitted below.

An operation performed by the information processing system 1 is substantially the same as that of the fifth embodiment, except for a process of determining the readout condition, the process being performed by the information processing server 10 in response to receiving a request for transmission of the presentation material 131 of the second conference. A description is given hereinafter of this process of determining the readout condition.

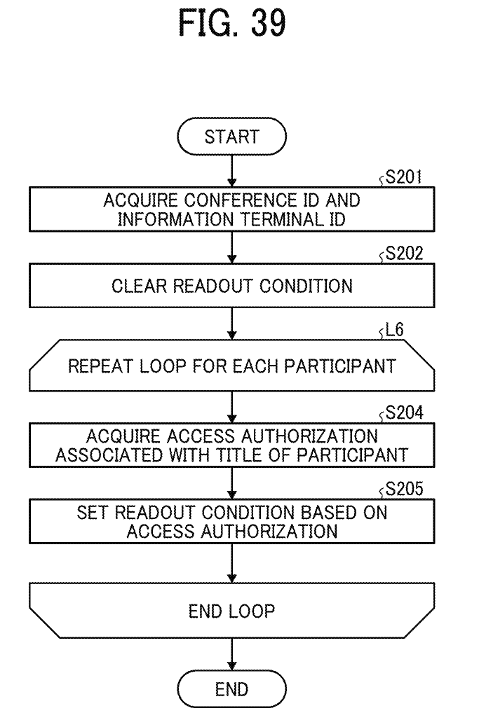

FIG. 39 is a flowchart illustrating steps in an operation of setting the readout condition performed by the information processing server 10 according to the sixth embodiment. In this example, a description is given hereinafter assuming that, in response to accepting entry of a conference ID on the conference ID input screen 601 illustrated in FIG. 14 and subsequently accepting selection of the ENTER key 603, the information terminal 30 transmits the entered content to the information processing server 10.

The acceptor 143 of the information processing server 10 acquires the conference ID and terminal information (information terminal ID) of the information terminal 30 that requested the conference ID (S201). Next, the readout condition acquisition unit 151 clears the readout condition (S202). Subsequently, the readout condition acquisition unit 151 performs a loop L6 from S204 to S205 for each participant of the second conference.

First, the readout condition acquisition unit 151 acquires the access authorization of a user associated with the terminal information (S204). Specifically, the readout condition acquisition unit 151 refers to the conference participant information 122 to acquire a participant name associated with the terminal information that is acquired at S201. Further, the readout condition acquisition unit 151 refers to the human resource information 123 to acquire a title of the acquired participant name. Furthermore, the readout condition acquisition unit 151 refers to the access authorization information 124 to acquire access authorization that is associated with the acquired title.

Subsequently, the readout condition acquisition unit 151 sets the readout condition based on the acquired access authorization (S205). For example, the readout condition acquisition unit 151 puts a check mark to a condition or conditions other than the condition specified by the access authorization. In other words, the readout condition acquisition unit 151 puts a check mark to a condition or conditions for which access is not allowed. This setting of readout condition is associated with each participant, for example.

After the readout condition acquisition unit 151 preforms the L6 from S204 to from S205 for each and every participant, the operation ends.

As described heretofore, according to the sixth embodiment, in response to receiving a request for transmission of the presentation material 131 from the information terminal 30, the information processing server 10 refers to the user information 121, the human resource information 123, and the access authorization information 124 using the terminal information of the information terminal 30 to acquire the access authorization. Further, the information processing server 10 sets the readout condition based on the acquired access authorization. Accordingly, the sixth embodiment enables automatic setting of the masking condition based on a title of the second conference participant without setting the readout condition in the second conference.

It should be noted that the embodiment in which the information processing server 10 is used in the above-described examples may be implemented as a function or functions provided by a network service such as a so-called cloud service and an application service provider (ASP). Further, the information processing server 10 used in such service may be implemented by a single apparatus. Alternatively, functions or processes described in the above may be distributed over multiple apparatuses.

Furthermore, an information processing program executed on each of the information processing server 10 and the information terminal 30 according to the above-described embodiments may be installed in any desired computer-readable format, such as a CD (compact disc)-ROM, flexible disc (FD), CD-R, and digital versatile disc (DVD), or in a format installable and executed by a computer, for distribution.

Further, the program executed on each of the information processing server 10 and the information terminal 30 according to the above-described embodiments may be stored on a computer connected to a network such as the Internet and downloaded via the network. Furthermore, the program executed on each of the information processing server 10 and the information terminal 30 according to the above-described embodiments may be provided or distributed via a network such as the Internet.

Further, the program according to the above-described embodiments may be provided as being preloaded in a ROM and the like.

The program executed on the information processing server 10 according to the above-described embodiments has a module configuration including the above-described units (the communication unit 11, the presentation material management unit 141, the masking information adder 142, the acceptor 143, the masking information determiner 144, the decider 145, the conference participant management unit 146, the device controller 147, the temporary file generator 148, the temporary file storage unit 149, the temporary file deletion unit 150, and the readout condition acquisition unit 151). As to actual hardware, the CPU 101 (processor) reads out the information processing program from the computer-readable medium for execution to load the program onto a main memory such as the RAM 102 to implement each of the communication unit 11, the presentation material management unit 141, the masking information adder 142, the acceptor 143, the masking information determiner 144, the decider 145, the conference participant management unit 146, the device controller 147, the temporary file generator 148, the temporary file storage unit 149, the temporary file deletion unit 150, and the readout condition acquisition unit 151 on the main memory.

Further, the information processing program executed on the information terminal 30 according to the above-described embodiments has a module configuration including the above-described embodiments (the operation controller 31, the display controller 32, the wireless communication controller 33, and the client application 34). As to actual hardware, the CPU 301 (processor) reads out the information processing program from the computer-readable medium for execution to load the program onto a main memory such as the RAM 302 to implement each of the operation controller 31, the display controller 32, the wireless communication controller 33, and the client application 34 on the main memory.

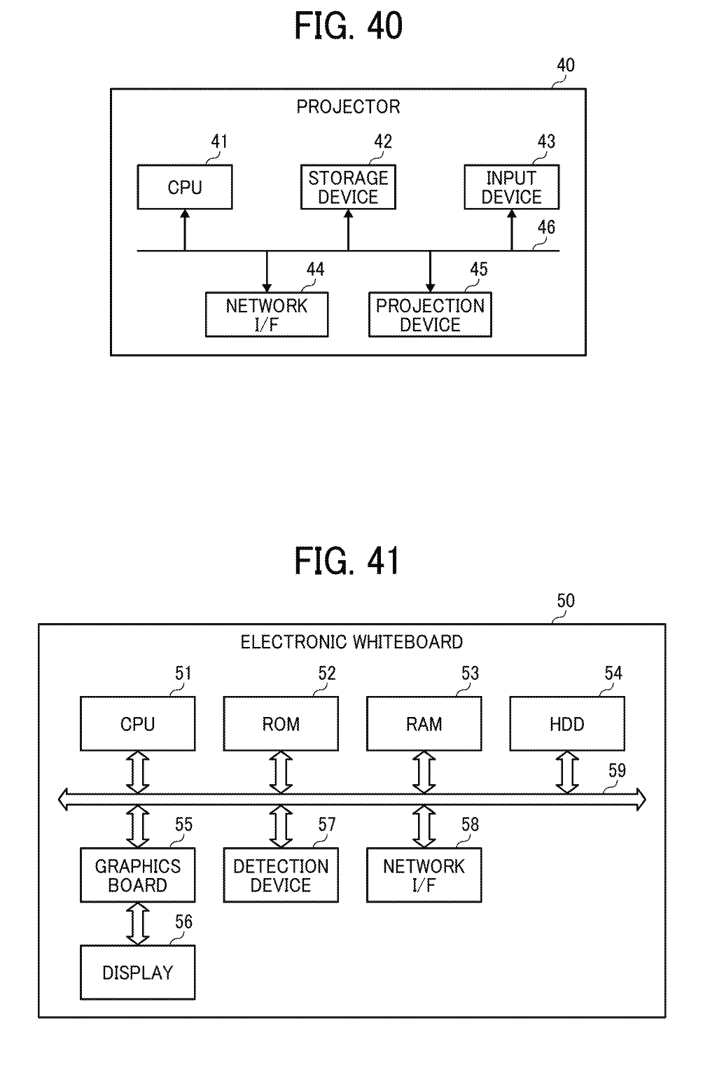

FIG. 40 is a block diagram illustrating an example hardware configuration of the projector 40. As illustrated in FIG. 40, the projector 40 includes a CPU 41, a storage device 42, an input device 43, a network interface 44, and a projection device 45, which are connected to each other via a bus 46.

The CPU 41 executes a program stored in the storage device 42 to control an overall operation of the projector 40. The storage device 42 includes a ROM and an HDD storing the program executed by the CPU 41 and data required for execution of the program, and a RAM that functions as a work area when the CPU 41 executes the program. The input device 43 accepts various inputs to the projector 40. Examples of the input device 43 include a touch panel and keys. The network interface 44 is an interface that connects the projector 40 to the network 80. The projection device 45 projects image data to be projected onto a projection object such as a screen. The projection device 45 includes a projection optical system including a projection lens.

FIG. 41 is a block diagram illustrating an example hardware configuration of the electronic whiteboard 50. As illustrated in FIG. 41, the electronic whiteboard 50 includes a CPU 51, a ROM 52, a RAM 53, an HDD 54, a graphics board 55, a display 56, a detection device 57, and a network interface 58, which are connected to each other via a bus 59.

The CPU 51 executes a program that is loaded from the ROM 52, HDD 54, etc., to the RAM 53 to control an overall operation of the electronic whiteboard 50. The graphics board 55 is a device that processes drawing data to be displayed on the display 56. The graphics board 55 includes a video RAM (VRAM) that stores image data and a video connector of the display 56. The display 56 is a display device that displays the drawing data generated by the graphics board 55.

The detection device 57 detects that an object touches or approaches the detection device 57. The detection device 57 is, for example, a touch panel including a capacitance sensor that detects change of capacitance when an object such as a finger and a dedicated stylus touches the touch panel. In response to detection of a touch position coordinate or an approach position coordinate by the detection device 57, the graphics board 55 draws a drawn image (handwritten image) based on the detected touch position coordinate or the approach position coordinate. Further, the graphics board 55 superimposes the drawn image on a background image. The network interface 58 is an interface that connects the electronic whiteboard 50 to the network 80.

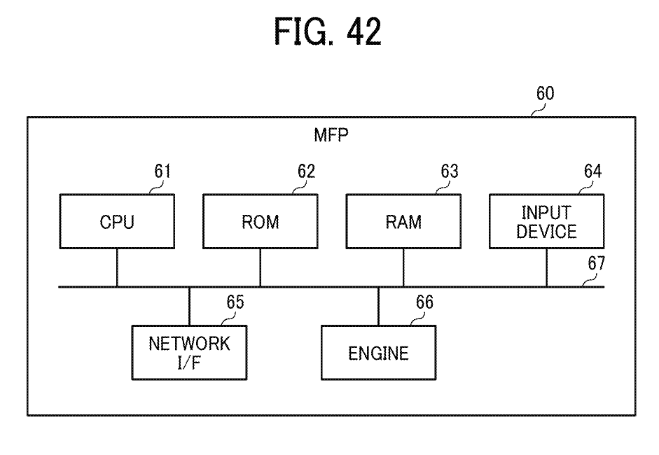

FIG. 42 is a block diagram illustrating an example hardware configuration of the MFP 60. As illustrated in FIG. 42, the MFP 60 includes a CPU 61, a ROM 62, a RAM 63, an input device 64, a network interface 65, and an engine 66, which are connected to each other via a bus 67.

The CPU 61 executes a program that is loaded from the ROM 62 or the like to the RAM 63 to control an overall operation of the MFP 60. The input device 64 accepts various inputs to the MFP 60. Examples of the input device 64 include a touch panel and keys. The network interface 65 is an interface that connects the MFP 60 to the network 80.

The engine 66 is hardware that performs processing other than general purpose information processing and communications. For example, the engine 66 implements a copier function, a scanner function, a facsimile function, and a printer function. The engine 66 includes, for example, a scanner (image reading unit) that scans and reads an image on a document, a plotter (image forming unit) that performs printing on a sheet such as paper, and a facsimile unit that performs facsimile communication.

### Seventh Embodiment

In the first to sixth embodiments, the viewing permission list is generated regardless of in which conference the conference participant participated in the past. Hereinafter, a description is given of a seventh embodiment that improves convenience of the viewing permission list for a conference participant who participates in the first conference and the second conference, when viewing presentation materials to which a mask is set in the first conference in the second conference.

The information processing server 10 according to the seventh embodiment has substantially the same configuration as that of the information processing server 10 according to the first embodiment as illustrated in FIG. 3, except that the acceptor 143 according to the seventh embodiment receives, from the information terminal 30, information identifying a conference participant as well as a conference ID of which presentation material 131 is desired. Examples of the information identifying the conference participant include identification information of the information terminal 30 that the conference participant possesses (uses), and identification information of the conference participant. When the decider 145 generates the viewing permission list for a given conference participant when the given conference participant participates in the second conference, the decider 145 determines whether the given conference participant participated in the first conference. In a case in which the decider 145 determines that the given conference participant participated in the first conference, the decider 145 transmits, to the information terminal 30 of the given conference participant, information that was specified as a masking target in the first conference. Specifically, the decider 145 generates a viewing permission list including a personal viewing list and a public viewing list. The personal viewing list indicates a file or files that can be viewed on the information terminal 30 of the given conference participant. The public viewing list indicates a file or files that can be viewed on a device other than the information terminal 30 of the given conference participant. The device other than the information terminal 30 is a device, such as the projector 40, the electronic whiteboard 50, and the MFP 60, that enables a conference participant other than the given conference participant to view information.

A description is given hereinafter of an example case in which the viewing permission list is generated when a conference participant ‘Mr. A’ in the conference participant information 122 illustrated in FIG. 5 participates in a second conference. The conference participant Mr. A participates in a first conference identified by a conference ID ‘0001’ and a second conference identified by a conference ID ‘0002’. An example case is assumed in which the first conference is an upper-level conference dealing with a management issue or the like, the second conference is a lower-level conference whose target is rank-and-file employees, and the conference participant Mr. A is responsible for explaining decisions, that were made in the first conference, in the second conference.

As illustrated in FIG. 6, from among the presentation materials of the first conference, that is, ‘Corporate Policy.ppt’, ‘Supplemental Document.doc’, ‘Illustration of Policy.jpg’ and ‘Supplemental Text.txt, ‘all’ is set to the masking information of ‘Supplemental Document.doc’ and ‘Illustration of Policy.jpg’. Accordingly, in the first embodiment, when the presentation materials of the first conference are to be viewed in the second conference, all participants Mr. A, Mr. F, Mr. G, and Ms. H cannot view ‘Supplemental Document.doc’ and ‘Illustration of Policy.jpg’. However, in fact, Mr. A is a person who participated in the first conference, and he was there when the mask settings were configured. Accordingly, in most cases, there would be no problem for Mr. A to view the files to which a mask was set, i.e., ‘Supplemental Document.doc’ and ‘Illustration of Policy.jpg’ in the second conference. However, in fact, Mr. A is a person who participated in the first conference, and he was there when the mask settings were configured. Accordingly, in most cases, there would be no problem for Mr. A to view, in the second conference, the files to which a mask was set, i.e., ‘Supplemental Document.doc’ and ‘Illustration of Policy.jpg’. For this reason, in the seventh embodiment, the viewing permission list is generated that enables Mr. A, as a conference participant who participated in the first conference during which a mask was set to given conference information, to view the information to which the mask was set in the second conference.

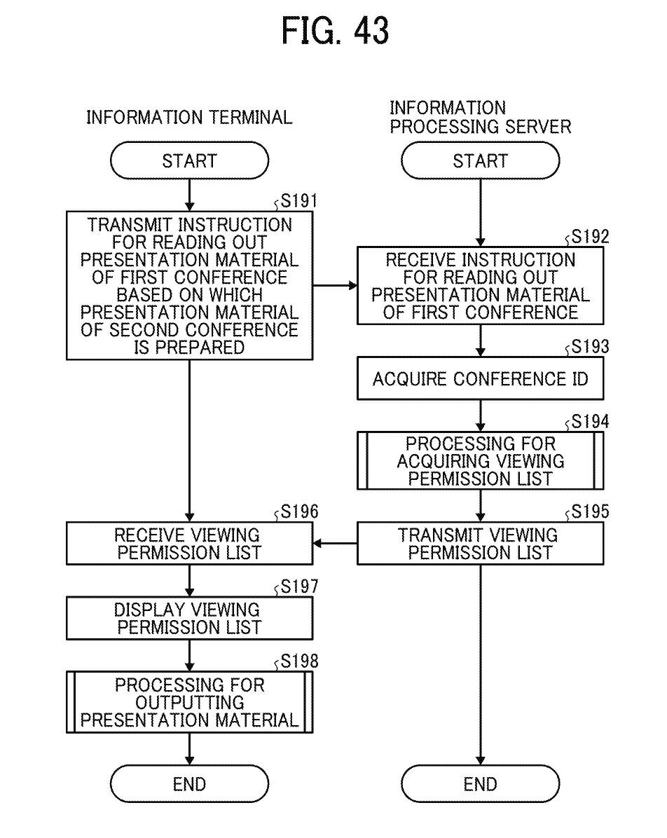

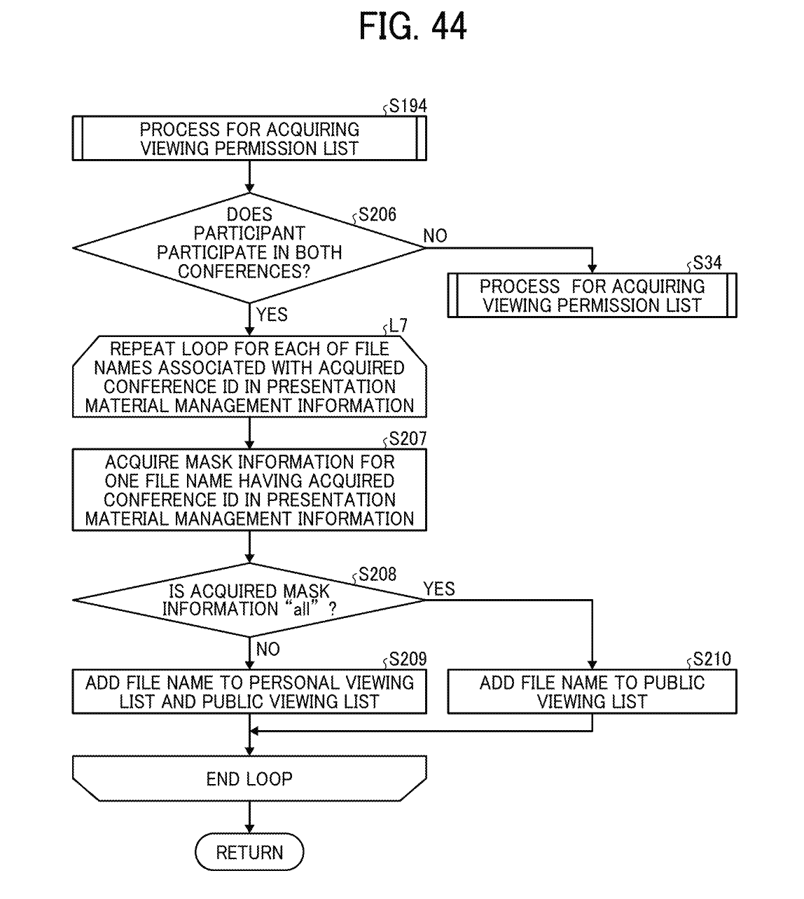

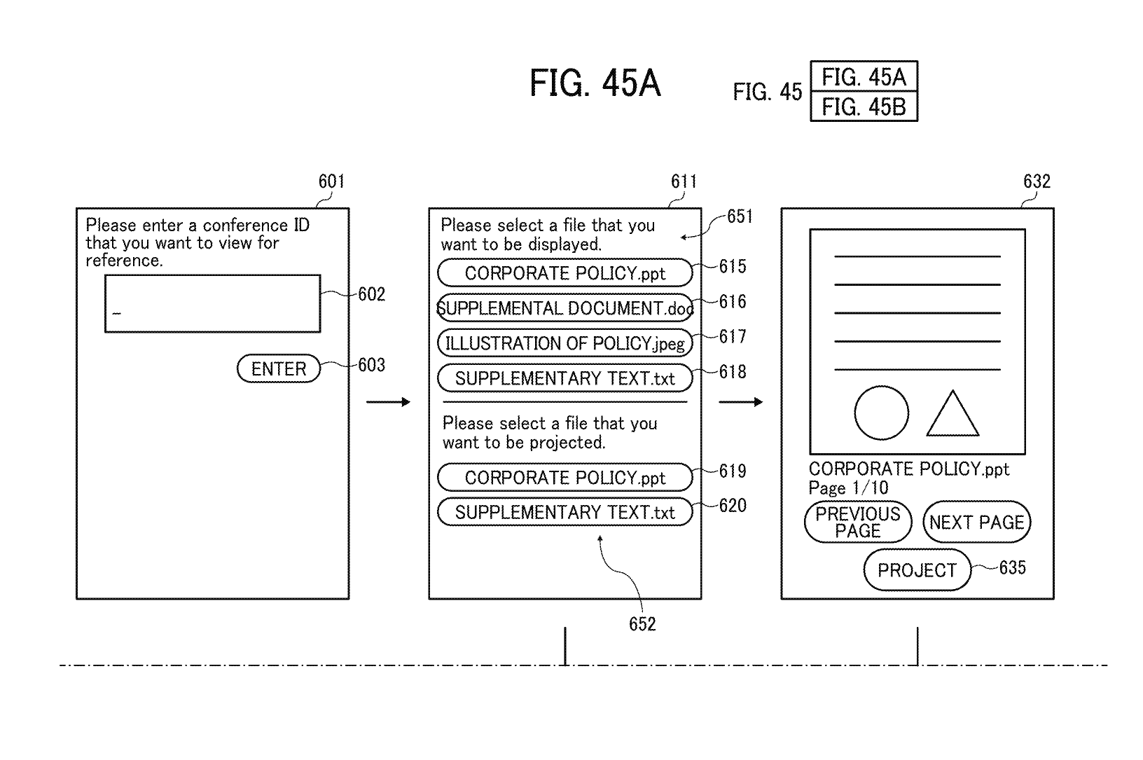

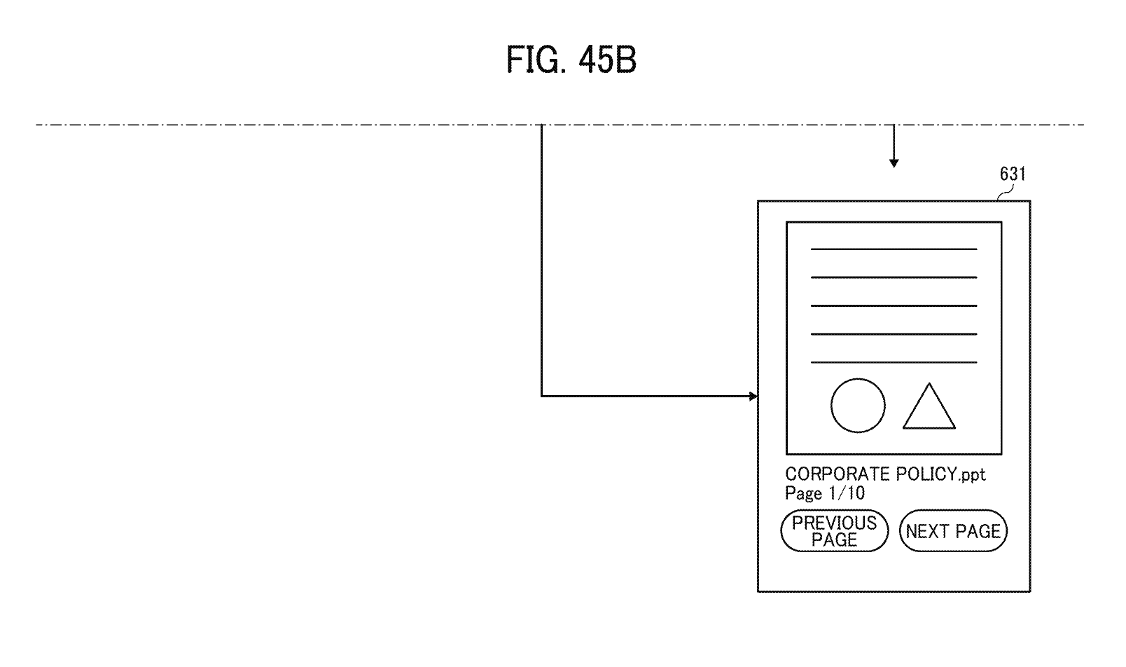

FIG. 43 is a flowchart illustrating steps in an operation of transmitting the presentation material 131 according to the seventh embodiment. FIG. 44 is a flowchart illustrating steps in an operation of acquiring the viewing permission list according to the seventh embodiment. FIGS. 45A and 45B illustrate an example of a display screen displayed on the information terminal 30 in a transmission process of presentation materials according to the seventh embodiment.

First, the conference ID input screen 601 as illustrated in FIG. 45A is displayed on the display device 306 of the information terminal 30 that the conference participant Mr. A possesses. On this conference ID input screen 601, the conference participant Mr. A enters, in the conference ID entry field 602, a conference ID ‘0001’ identifying the first conference, and thereafter presses the ENTER key 603. Based on this input by Mr. A, the readout file designation unit 342 of the information terminal 30 transmits, to the information processing server 10 via the wireless communication controller 33, an instruction for reading out the presentation material 131 of the first conference based on which the presentation material 131 of the second conference is to be generated. In addition, the readout file designation unit 342 transmits, to the information processing server 10, the terminal information (a, b, c, etc., in FIG. 4) that is uniquely allocated to the information terminal 30 (S191). The instruction contains the conference ID of the first conference. The terminal information is stored in any suitable memory included in the information terminal 30. It should be noted that the terminal information is an example of information that can identify the conference participant Mr. A, and therefore, as an alternative of the terminal information, a user ID or the like assigned to the conference participant Mr. A may be transmitted.

The acceptor 143 of the information processing server 10 receives the instruction and the terminal information (S192). The decider 145 acquires the conference ID from the received instruction, and further acquires the user ID from the received terminal information by using the user information 121 illustrated in FIG. 4 (S193). Further, the decider 145 acquires the viewing permission list (S194).

With reference to FIG. 44, a description is given of the acquisition of the viewing permission list performed at S194 in FIG. 43. The masking information determiner 144 and the decider 145 refers to the conference participant information 122 as illustrated in FIG. 5 to determine whether a conference participant corresponding to the acquired user ID participates in both the first conference (conference ID: 0001) and the second conference (conference ID: 0002) (S206). In a case in which the conference participant does not participate in the both conferences (S206: NO), that is, in a case in which the conference participant participates only in the second conference, the process of acquiring the viewing permission list as performed at S34 in FIG. 13 is performed. By contrast, in a case in which the conference participant participates in the both conferences (S206: YES), the masking information determiner 144 and the decider 145 performs L7 from S207 to S210 for each of files respectively identified by file names associated with the acquired conference ID.

First, for a given one of the file names that are associated with the acquired conference ID in the presentation material management information 132, the masking information determiner 144 acquires the masking information (S207). Subsequently, the masking information determiner 144 determines whether the acquired masking information is ‘all’ (S208). In a case in which the acquired masking information is not ‘all’ (S208: NO), the decider 145 adds the file name as the current determination target to both alternatives of the personal viewing list and alternatives of the public viewing list (S209). By contrast, in a case in which the acquired masking information is ‘all’ (S208: YES), the decider 145 adds the file name as the current determination target to alternatives of only the public viewing list (S210). When the loop L7 from S207 to S210 is performed for each and every file name associated with the acquired conference ID, the process of acquiring the viewing permission list ends.

Referring again to the flowchart of FIG. 43, the communication unit 11 transmits the viewing permission list including the personal viewing list and the public viewing list to the information terminal 30 (S195). In response to receiving the viewing permission list (S196), the readout file designation unit 342 of the information terminal 30 displays the viewing permission list on the display device 306 (S197).

For example, the viewing permission list is displayed on the display device 306 in a form of the viewing permission list display screen 611 as illustrated in FIG. 45A. On the viewing permission list display screen 611, displayed are a personal viewing list 651 and a public viewing list 652.

The personal viewing list 651 indicates files that can be displayed on the display device 306 of the information terminal 30 possessed by Mr. A, who participates in both of the first conference and the second conference. The personal viewing list 651 illustrated in FIG. 45A contains all of the presentation materials of the first conference. On the viewing permission list display screen 611 illustrated in FIG. 45A, displayed are a ‘Corporate Policy.ppt’ key 615, a ‘Supplemental Document.doc’ key 616, an ‘Illustration of Policy.jpg’ key 617, and a ‘Supplemental Text.txt’ key 618, each being an alternative of the personal viewing list 651. Each of the keys 615 to 618 is an example of an operation unit that accepts selection made by Mr. A as a conference participant who possesses the information terminal 30.

The public viewing list 652 indicates files that can be outputted (including projection, display and print) to a device, such as the projector 40, the electronic whiteboard 50 and the MFP 60, other than the information terminal 30 possessed by the conference participant Mr. A. In an example illustrated in FIG. 45A, files that can be projected on the projector 40 are indicated. The public viewing list 652 contains only files for which ‘all’ is not set to the masking information, from among presentation materials of the first conference. On the viewing permission list display screen 611 illustrated in FIG. 45A, displayed are a ‘Corporate Policy.ppt’ key 619 and a ‘Supplemental Text.txt’ key 620, each being an alternative of the public viewing list 652. Each of the keys 619 and 620 is an example of an operation unit that accepts selection made by Mr. A as a conference participant who possesses the information terminal 30.

Referring again to the flowchart of FIG. 43, the client application 34 of the information terminal 30 displays the viewing permission list (S197), and thereafter outputs the presentation materials (S198).

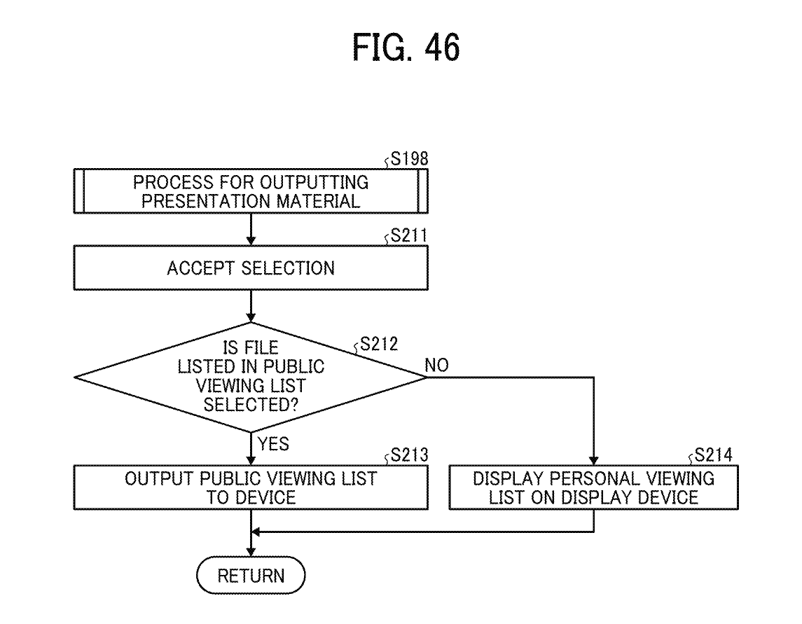

FIG. 46 is a flowchart illustrating steps in an operation of outputting the presentation materials performed at S198 of FIG. 43 according to the seventh embodiment. The client application 34 accepts input by the conference participant Mr. A on the viewing permission list display screen 611 (S211). Specifically, the conference participant Mr. A selects a key corresponding to a file that Mr. A wants to display on the display device 306 of the information terminal 30, from among the keys 615 to 618 of the personal viewing list 651 displayed on the viewing permission list display screen 611. Alternatively, the conference participant Mr. A selects a key corresponding to a file that Mr. A wants to output to the device, such as the projector 40, the electronic whiteboard 50, and the MFP 60 (in an example illustrated in FIG. 45A, a file that Mr. A wants to project on the projector 40) from among the keys 619 and 620 of the public viewing list 652.

The client application 34 determines that a file in the public viewing list 652 (S212) is selected. In a case in which a file in the public viewing list 652 is selected (S212: YES), e.g., in a case in which either one of the ‘Corporate Policy.ppt’ key 619 and the ‘Supplemental Text.txt’ key 620 is tapped, the client application 34 performs processing for outputting the selected file to a device (S213). For example, the client application 34 transmits the selected file to the projector 40 to enable the projector 40 to project the selected file. This enables all of the participants in the second conference to view a file that is output to the device. At this time, only files (Corporate Policy.ppt or Supplemental Text.txt) for which ‘all’ is not set in the masking information can be output to the device.

FIG. 45B illustrates an example of a public preview screen 631 that is displayed, on the display device 306 of the information terminal 30, when a file in the public viewing list 652 is selected. On the public preview screen 631 of this example, displayed is a preview of a file to be output to a device, e.g., to be projected on the projector 40.

Referring again to the flowchart of FIG. 46, in a case in which a file in the public viewing list 652 is not selected (S212: NO), i.e., in a case in which a file in the personal viewing list 651 is selected, the client application 34 performs processing for displaying the selected file on the display device 306 of the information terminal 30 (S214). For example, when any one of the ‘Corporate Policy.ppt’ key 615, the ‘Supplemental Document.doc’ key 616, the ‘Illustration of Policy.jpg’ key 617 and the ‘Supplemental Text.txt’ key 618 is tapped, the client application 34 performs processing for receiving the selected file from the information processing server 10. This enables Mr. A, who participated in the first conference, to view all presentation materials including a file for which ‘all’ is set in the masking information on the information terminal 30 during the second conference.

FIG. 45A illustrates an example of a personal viewing screen 632 that is displayed, on the display device 306 of the information terminal 30, when a file in the personal viewing list 651 is selected. On the personal viewing screen 632 of this example, displayed are a content of the selected file, a PROJECT key 635, etc. The PROJECT key 635 accepts an instruction for outputting (e.g., projecting to the projector 40) a file displayed on the personal viewing screen 632, such as Corporate Policy.ppt or Supplemental Text.txt, for which ‘all’ is not set in the masking information. For this reason, the PROJECT key 635 is not displayed in a case in which a file, such as Supplemental Document.doc and Illustration of Policy.jpg, for which ‘all’ is not set in the masking information, is displayed on the personal viewing screen 632.

Although in the seventh embodiment, a description is given of an example case in which a device to which a public view file is outputted is the projector 40, a user (a conference participant Mr. A) may select a device to which a public view file is outputted.

For example, the viewing permission list display screen 611 may further include a key that accepts selection of the device, such as the projector 40, the electronic whiteboard 50, and the MFP 60, to which the public view file is outputted.

In addition, although in the seventh embodiment, a description is given of an example case in which the masking information setting is performed on a file-by-file basis as in the first embodiment, the setting of masking information may be performed on a page-by-page basis, and/or to specify an area or text as in the second to fourth embodiments.

As described heretofore, the seventh embodiment enables a conference participant who participates in both the first conference and the second conference to view presentation material to which a mask is set in the first conference, on the participant's own information terminal 30 during the second conference. In addition, during the second conference, presentation material to which no mask is set is output to a device such as the projector 40, enabling a conference participant who participates only in the second conference to view the outputted presentation material. This enables optimization of information that a conference participant who participates in plural conferences can view and information that a conference participant who participates in only one conference can view.

According to embodiments of the present disclosure, when shared information that is used in a first group is referenced in a second group, it is possible to impose restriction on a range that can be referenced in the second group without increase of a size of the shared information stored in the information processing apparatus.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An information processing apparatus comprising:
a memory to store:
shared information,
identification information identifying each file of shared information in association with identification information of a group of users who share a use of the shared information, and
user identification information identifying a user in association with the identification information of the group; and
circuitry to:
associate, with at least one file of shared information stored in the memory, masking information defining a masking target that a different group from the group associated with the file of the shared information is restricted from using,
accept, from an information terminal, designation of a group for usage of the shared information,
determine whether any file of the shared information associated with the designated group is associated with the masking information,
determine one or more files of shared information to be transmitted to the information terminal based on whether any file of the shared information is associated with the masking information, and
transmit the determined shared information to the information terminal.

2. The information processing apparatus of claim 1, wherein
in the accepting the designation of the group, the circuitry receives, from the information terminal, information that identifies a user who instructed the designation, and
in a case in which the user who instructed the designation is associated with the designated group, the circuitry determines the shared information to be transmitted to the information terminal of the user who instructed the designation so as to enable the user who instructed the designation to use the masking target in the different group.

3. The information processing apparatus of claim 1, wherein
the masking information defines the masking target on a file-by-file basis, and
in a case in which the shared information is to be transmitted to the information terminal of a user belonging to the different group, the circuitry determines that a file other than the masking target from among the files of the shared information is to be transmitted.

4. The information processing apparatus of claim 1, wherein
in a case in which the shared information is to be transmitted to the information terminal of the user belonging to the different group, and the masking information defines the masking target on a page-by-page basis in a file of the shared information,
the circuitry further:
applies a mask to a copy of a file for which the masking target is defined, based on the masking target, to generate a first temporary file,
stores the first temporary file in the memory,
in the determining of the shared information to be transmitted to the information terminal, determines the shared information to be transmitted to the user including the first temporary file, and
deletes the first temporary file from the memory after usage of the first temporary file by the user belonging to the different group.

5. The information processing apparatus of claim 4, wherein
in a case in which the shared information is to be transmitted to the information terminal of the user belonging to the different group, and the masking information defines an area within a page of a file of the shared information as the masking target,
the circuitry further:
generates an image file by converting each page of the file for which the area is defined as the masking target to an image,
applies a mask to the image file based on the masking target to generate a second temporary file,
stores the second temporary file in the memory, and
deletes the second temporary file from the memory after usage of the second temporary file by the user belonging to the different group.

6. The information processing apparatus of claim 4, wherein
in a case in which the shared information is to be transmitted to the information terminal of the user belonging to the different group, and the masking information defines, as the masking target, masked text or text containing before-replacement text and after-replacement text in a file of the shared information,
the circuitry further:
masks text or replaces text, based on the masking information, in a copy of a file for which the text is defined as the masking target, to generate a third temporary file,
stores the third temporary file in the memory, and
deletes the third temporary file from the memory after usage of the third temporary file by the user belonging to the different group.

7. The information processing apparatus of claim 1, wherein
the masking information further includes a mask execution condition for executing a specified masking to the masking target, and
in response to receiving, from the information terminal of a user, an instruction for requesting usage of a file of the shared information, the circuitry:
compares the mask execution condition in the masking information for the file of which usage is requested with a readout condition for reading out the file,
validates a mask that is set to the masking target of the masking information in a case in which no mask execution condition is set or the mask execution condition matches the readout condition, and
invalidates a mask that is set to the masking target in a case in which the mask execution condition does not match the readout condition.

8. The information processing apparatus of claim 7, wherein the readout condition is contained in the instruction requesting usage of a file of the shared information.

9. The information processing apparatus of claim 7, wherein
the memory further stores the readout condition for each user,
in response to receiving the instruction requesting a usage of a file of the shared information from the information terminal of the user belonging to the different group, the circuitry acquires, from the memory, the readout condition for the user of the information terminal from which the instruction is received, and
the circuitry further compares the masking execution condition using the acquired readout condition.

10. An information processing system comprising:
a memory to store:
shared information,
identification information identifying each file of shared information in association with identification information of a group of users who share a use of the shared information, and
user identification information identifying a user in association with the identification information of the group; and
circuitry to:
associate, with at least one file of shared information stored in the memory, masking information defining a masking target that a different group from the group associated with the file of the shared information is restricted from using,
accept, from an information terminal, designation of a group for usage of the shared information,
determine whether any file of the shared information associated with the designated group is associated with the masking information,
determine one or more files of shared information to be transmitted to the information terminal based on whether any file of the shared information is associated with the masking information, and
transmit the determined shared information to the information terminal.

11. An information processing method comprising:
storing, in a memory, shared information, identification information identifying each file of shared information in association with identification information of a group of users who share a use of the shared information, and user identification information identifying a user in association with the identification information of the group;
associating, with at least one file of shared information stored in the memory, masking information defining a masking target that a different group from the group associated with the file of the shared information is restricted from using;
accepting, from an information terminal, designation of a group for usage of the shared information;
determining whether any file of the shared information associated with the designated group is associated with the masking information;
determining one or more files of shared information to be transmitted to the information terminal based on whether any file of the shared information is associated with the masking information; and
transmitting the determined shared information to the information terminal.
